(19) United States
(12) Patent Application Publication
(10) Pub. No.: US 2024/0013564 A1
(43) Pub. Date: Jan. 11, 2024

(54) SYSTEM, DEVICES AND/OR PROCESSES FOR TRAINING ENCODER AND/OR DECODER PARAMETERS FOR OBJECT DETECTION AND/OR CLASSIFICATION

(71) Applicant: AKASA, Inc., South San Francisco, CA (US)

(72) Inventors: Byung-Hak Kim, San Jose, CA (US); Hariraam Varun Ganapathi, San Francisco, CA (US); Weiyao Wang, Baltimore, MD (US)

(21) Appl. No.: 18/474,672

(22) Filed: Sep. 26, 2023

Related U.S. Application Data
(63) Continuation-in-part of application No. 17/575,852, filed on Jan. 14, 2022.
(60) Provisional application No. 63/194,139, filed on May 27, 2021.
(60) Provisional application No. 63/377,322, filed on Sep. 27, 2022.
(60) Provisional application No. 63/421,874, filed on Nov. 2, 2022.
(60) Provisional application No. 63/384,744, filed on Nov. 22, 2022.

(51) Int. Cl. G06V 30/413; G06N 3/0455; G06N 3/0464; G06V 10/82

(52) U.S. Cl. CPC G06V 30/413; G06N 3/0455; G06N 3/0464; G06V 10/82

(57) ABSTRACT

Example methods, apparatuses, and/or articles of manufacture are disclosed that may be implemented, in whole or in part, using one or more computing devices to implement one or more encoding and/or decoding techniques.

This is a continuation-in-part of U.S. patent application Ser. No. 17/575,852, titled “SYSTEM, DEVICES AND/OR PROCESSES FOR SELF-SUPERVISED MACHINE-LEARNING,” filed on Jan. 14, 2022, which claims the benefit of priority under 35 USC § 119 (e) to U.S. Provisional Patent Application No. 63/194,139, titled “SYSTEM, DEVICES AND/OR PROCESSES FOR SELF-SUPERVISED MACHINE-LEARNING,” filed on May 27, 2021, which are incorporated herein by reference in their entirety. This application also claims the benefit of priority under 35 USC § 119 (e) to U.S. Provisional Patent Application Nos. 63/377,322, titled “SYSTEM, DEVICE AND/OR PROCESS FOR SELF-SUPERVISED TRAINING ENCODER AND/OR DECODER PARAMETERS,” filed on Sep. 27, 2022, 63/421,874, titled “SYSTEM, DEVICES AND/OR PROCESSES FOR TRAINING ENCODER AND/OR DECODER PARAMETERS FOR OBJECT DETECTION AND/OR CLASSIFICATION,” filed on Nov. 2, 2022, and 63/384,744 titled “SYSTEM, DEVICES AND/OR PROCESSES FOR TRAINING ENCODER AND/OR DECODER PARAMETERS FOR OBJECT DETECTION AND/OR CLASSIFICATION,” filed on Nov. 22, 2022, which are incorporated herein by reference in their entirety.

### BACKGROUND

### 1. Field

The present disclosure relates generally to machine-learning devices.

### 2. Information

Developments in self-supervised learning (SSL) have yielded visual representations having associated accuracy approaching an accuracy of visual representations obtained from fully supervised learning on large computer vision downstream tasks. To date, most SSL studies and systems have been directed to applications of well-curated data sets.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram of a computing apparatus, according to an embodiment;

FIG. 2 is a flow diagram of a process to determine parameters for mappings features of an electronic document to associated content domains, according to an embodiment;

FIG. 3 is a schematic diagram of a computing apparatus, according to an embodiment;

FIG. 4 is a schematic diagram of a system to implement training operations, according to an embodiment;

FIG. 5 is a flow diagram of a process to determine parameters of a computing system, according to an embodiment;

FIG. 6A is a schematic diagram of a computing system for detection and/or classification of objects in a content signal, according to an embodiment;

FIG. 6B is a flow diagram of a process for detection and/or classification objects in a content signal, according to an embodiment;

FIG. 6C is a flow diagram of a process for detection of features in a content signal, according to an embodiment;

FIG. 7A is a schematic diagram of a system to determine parameters of a computing system, according to an embodiment;

FIG. 7B is a flow diagram of a process for determination of parameters of a computing system, according to an embodiment;

FIGS. 7C and 7D are plots illustrating relative performance of techniques to train parameters of a computing system, according to embodiments;

FIG. 8 is a schematic block diagram of an example computing system in accordance with an implementation;

FIG. 9 is a schematic diagram of a neural network formed in “layers”, according to an embodiment; and

FIG. 10 is a flow diagram of an aspect of a training operation, according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

As pointed out above, self-supervised learning (SSL) techniques have yielded visual representations having an associated accuracy that approaches a level of accuracy enabled using fully supervised learning operations on large computer vision downstream tasks, for example.

While some implementations of an SSL training operations are directed to use of well-curated datasets, particular embodiments disclosed herein are directed to applications of structured document images. In a particular implementation, to develop an SSL approach for structured document images, an information bottleneck framework may be applied to derive a negative-sample-free contrastive learning objective. This may lead to simplified objective function that avoids negative pair construction and strong dependency on use of large batch sizes.

One embodiment disclosed herein is directed to a method comprising: obtaining first and second views of a content signal; applying a first encoder to the first view to provide a first encoded view; applying a second encoder to the second view to provide a second encoded view; applying a first decoder to the first encoded view to provide a recovered first view; applying a second encoder to the second view to provide a second encoded view; and updating parameters of the first encoder, the second encoder, first decoder or the second decoder, or a combination thereof, based, at least in part, on a cross-correlation of features of the first encoded view and the second encoded view.

Another embodiment disclosed herein is directed to a method comprising: extracting samples of a content signal; applying the extracted samples as an input to an encoder to provide an encoding of the extracted samples; applying the encoding of the extracted samples as an input to a decoder trained to provide a reconstruction of the content signal; populating an input tensor with values based, at least in part, on intermediate states of the decoder; executing the one or more neural networks to obtain an output tensor; and detecting one or more features in the content signal based, at least in part, on the output tensor.

Another embodiment is directed to a method of training a system for detection of objects in a content signal, the method comprising: applying a self-supervised operation to train parameters of an encoder and a decoder based, at least in part, on a first loss function based, at least in part, on a computed loss associated with reconstruction of a view of the content signal; and applying a supervised operation to further train parameters of the encoder and the decoder trained in the self-supervised operation based, at least in, in part, on a second loss function based, at least in part, on a computed loss associated with detection of objects.

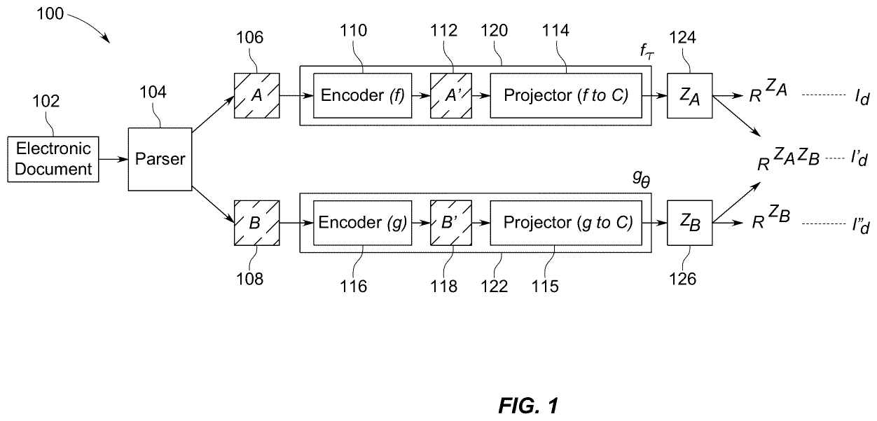

FIG. 1 is a schematic diagram of aspects of a computing system 100 implementing a system to facilitate an SSL machine-learning technique, according to an embodiment. An electronic document 102 may be received at parser 104 to provide patch sequences A and B. In a particular implementation, electronic document 102 may comprise signals expressing content in any one of several forms including, for example, image pixels, audio signals, sensor observations or measurements, raw sensor signals or content encoded according to a particular encoded format (e.g., JPEG, MPEG, MP3, ASCI, etc.), or a combination thereof, just to provide a few examples. As such, “patches” as referred to herein is not limited to a region of contiguous pixels in an image and/or image frame, and may include other samples, groupings of samples and/or other segments of a content signal, overlapping or non-overlapping.

According to an embodiment, parser 104 may generate patch sequences A and B based, at least in part, on features detected in and/or extracted from electronic document 102. In a particular implementation, parser 104 may generate patch sequences A and B based, at least in part, on features detected in and/or extracted from electronic document 102 in different content domains for respective patch sequences A and B. In one particular example, electronic document 102 may comprise image pixel values expressing a mixture of objects including text objects and non-text objects (e.g., objects visible in a scene such as humans, written document formatting features, animals, plants, building structures, commercial products, etc.). Here, parser 104 may generate patch sequence A as non-text objects detected in and/or extracted from electronic document 102 while generating patch sequence B as a text sequence, for example. To generate patch sequence B as a text sequence, for example, parser 104 may implement optical character recognition to detect and/or extract text objects from pixel values in electronic document 102. In another example, electronic document 102 may comprise an audio signal including a mixture of components including, for example, human voices, sounds from a machine, a barking dog, automobile horn, etc. Here, parser 104 may generate patch sequence A as non-human voice features detected in and/or extracted from electronic document 102 (e.g., non-human sounds expressed in electronic document 102). Patch sequence B may be generated as text of words/phrases detected in and/or extracted from a human voice component of sounds expressed in electronic document 102. To generate patch sequence B as a text sequence, for example, parser 104 may implement a voice-to-text process to detect and/or extract text objects from an audio signal in electronic document 102 identified as being from of a human voice. It should be understood, however, that these are merely examples of how a parser may generate different patch sequences in respectively different content domains from an electronic document, and claimed subject matter is not limited in this respect.

According to an embodiment, processing branch 120 may process patch sequence A according to a first content domain and processing branch 122 may process patch sequence A according to a second content domain which is distinct and different from the first content domain. Nonetheless, processing paths 120 and 122 map output results to a common domain. According to an embodiment, encoders 110 and 116 may map features in patch sequences A and B to respectively different encoded domains content domains 112 (as encoded patch sequence A′) and 118 (as encoded patch sequence B′), for example. If features expressed electronic document 102 are parsed into patch sequences A and B respectively having text features and visual object features (as in the above example), encoded patch sequence A′ may comprise symbols and/or expressions encoded to represent text features and encoded patch sequence B′ may comprise symbols and/or expressions encoded to represent visual object features. Similarly, audio signal features expressed electronic document 102 may be parsed into patch sequences A and B respectively having voice-to-text features and non-human sound features. Encoded patch sequence A′ may then comprise symbols and/or expressions encoded to represent text features and encoded patch sequence B′ may comprise symbols and/or expressions encoded to represent non-human sound/audio features, for example.

Visually rich content in electronic document 102 may be parsed into patch sequences A and B respectively having text features and visual object features. Encoded patch sequence A′ may then comprise symbols and/or expressions encoded to a text sequence. Likewise, encoded patch sequence B′ may comprise symbols and/or expressions encoded to represent a corresponding region image sequence. In another example, an instructional audio-visual presentation in electronic document 102 may be parsed into patch sequences A and B respectively having an instructor's voice features and visual image features. Encoded patch sequence A′ may then comprise symbols and/or expressions encoded to represent the instructor's narrative (e.g., in audio symbols and/or text symbols) and encoded patch sequence B′ may comprise symbols and/or expressions encoded to represent a corresponding series of video images. In yet another example, a medical record in electronic document 102 may be parsed into patch sequences A and B respectively having a representation of clinical notes (e.g., in audio or written format) and features of a clinical image (e.g., X-ray and/or MRI image). Encoded patch sequence A′ may comprise symbols and/or expressions encoded to represent a clinician's description (e.g., in audio symbols and/or text) and encoded patch sequence B′ may then comprise symbols and/or expressions encoded to represent a corresponding series of still images.

While encoded patch sequences A′ and B′ may comprise symbols and/or expressions to represent features in different content domains, such symbols and/or expressions represented in encoded patch sequences A′ and B′ may nonetheless be correlated. For example, such symbols and/or expressions represented in encoded patch sequences A′ and B′ may be correlated with respect to a time domain, environmental context domain, situational context domain, just to provide a few examples. According to an embodiment, such a correlation of symbols and/or expressions represented in encoded patch sequences A′ and B′ may enable use of symbols and/or expressions in encoded patch sequence A′. Such a correlation of symbols and/or expressions may be used to derive a supervisory signal to assist in a machine-learning process to refine parameters defining processing paths 120 and 122.

According to an embodiment, projectors 114 and 115 may transform symbols and/or expressions in encoded patch sequences A′ and B′ to a common domain Z, where Z_{A} and Z_{B} respectively represent transformation of symbols and/or expressions in encoded patch sequences A′ and B′ to common domain Z. In a particular implementation, such a mapping of encoded patch sequences A′ and B′ to a common domain Z as Z_{A} and Z_{B} may enable one or more machine-learning processes to derive parameters for elements of processing paths 120 and 122 (e.g., encoders 110 and 116, and projectors 114 and 115), for example. In a particular example implementation, encoders 110 and 116, and projectors 114 and 116 may be implemented, at least in part, using neural networks and a machine-learning process may update/refine aspects of such neural networks based, at least in part, on Z_{A} and Z_{B} using backpropagation, for example.

According to an embodiment, domain Z may define a compressed format such that processing path 120 provides Z_{A} as a compression/compressed representation of patch sequence A and processing path 122 provides Z_{B} as a compression/compressed representation of patch sequence B. In a particular implementation, processing path 120 may compress patch sequence A occupying an uncompressed digital data size (e.g., quantified by bits or bytes) to provide a compressed representation Z_{A} that occupies a smaller digital data size. Likewise, processing path 120 may compress patch sequence B occupying an uncompressed digital data size (e.g., quantified by bits or bytes) to provide a compressed representation Z_{B} that occupies a smaller digital data size. According to an embodiment, parameters to define encoder 110 and projector 114 may be selected so as to compress A into Z_{A} while preserving information regarding features of patch sequence B in Z_{A}. Similarly, parameters to define encoder 116 and projector 115 may be selected so as to compress B into Z_{B} while preserving information regarding features of patch sequence A in Z_{B}. In a particular example in which A is a patch sequence of an image of a visual object and B is a patch sequence of text relating to features of the visual object, parameters of encoder 110 and projector 114 may be determined so as to preserve information relating to text features of B in Z_{A}. Similarly, parameters of encoder 116 and projector 115 may be determined so as to preserve information relating to text features of A in Z_{B}. According to an embodiment, parameters of encoders 110 and/or 116, and projectors 114 and/or 116 may be determined in machine learning operations according to a loss function that models loss of information about patch sequence A in Z_{B} and/or models loss of information about patch sequence B in Z_{A}.

According to an embodiment, features of neural networks to implement encoders 110 and/or 116, and projectors 114 and/or 116 (e.g., weights and/or numerical coefficients to be applied to and/or associated with nodes and/or edges in such neural networks) may be determined in backpropagation operations applied to a loss function. In a particular implementation, features of neural networks to implement encoders 110 and/or 116, and projectors 114 and/or 116 may be determined in iterations of backpropagation applied to a loss function that models loss of information about patch sequence A in compressed representation Z_{B} and/or models loss of information about patch sequence B in compressed representation Z_{A}. In a particular implementation, a loss function for such iterations of backpropagation may be provided as a loss function L in expression (1) as follows:

$$\begin{matrix}L = I ( {Z}_{A} ; A ) + I ( {Z}_{B} ; B ) - {α}_{1} I ( {Z}_{A} ; {Z}_{B} ) \\ = h ( {Z}_{A} ) - h ( {Z}_{A} \vert A ) + h ( {Z}_{B} ) - h ( {Z}_{B} \vert B ) - {α}_{1} h ( {Z}_{A} ) - {α}_{1} h ( {Z}_{B} ) + \\ {α}_{1} h ( {Z}_{A} , {Z}_{B} ) \\ = ( 1 - {α}_{1} ) h ( {Z}_{A} ) + ( 1 - {α}_{1} ) h ( {Z}_{B} ) + {α}_{1} h ( {Z}_{A} , {Z}_{B} )\end{matrix} \qquad ( 1 )$$

where:
I(Z_{A};A) represents mutual information of Z_{A} and patch sequence A;
I(Z_{B};B) represents mutual information of Z_{B} and patch sequence B;
I(Z_{A}; Z_{B}) represents mutual information of Z_{A} and Z_{B}; and
h is a function representing differential entropy
α₁ is a tunable parameter.

As pointed out above, in a particular implementation, Z_{A} and Z_{B} may be modeled as two jointly multivariate Gaussian variables with zero means and covariance matrices K_{A}∈ [symbol] ^{dxd} and K_{B}∈ [symbol] ^{dxd}, which may be full rank. In an embodiment, entropy of a d-dimensional Gaussian variable may be modeled according to expression (2) as follows:

h(Z)=½ log [(2πe)^{d}|K_{Z}|], (2)

where |K_{Z}| denotes a determinate of K_{Z}. A loss function of expression (1) may then be reduced as shown in expression (3) as follows:

L=log (|K_{Z}_{_{A}}|)+log (|K_{Z}_{_{B}}|)+β₁ log (|K_{Z}_{_{A}}_{Z}_{_{B}}), (3)
where:
K_{Z}_{_{A}} is a covariance matrix of Z_{A};
K_{Z}_{_{B}} is a covariance matrix of Z_{B};
K_{Z}_{_{A}}_{Z}_{_{B}} is a cross-covariance matrix of Z_{A} and Z_{B};

$${β}_{1} {=}^{△} ( \frac{1 - {α}_{1}}{{α}_{1}} ) .$$

According to an embodiment, an upper bound of log (|K|) may be modeled according to expression (4) as follows:

log (|K|)=log (Πᵢ₌₁ⁿλᵢ)=Σᵢ₌₁ⁿ log λᵢ<Σᵢ₌₁ⁿλᵢ²=∥K∥_{F}², (4)
where:
λ₁, λ₂, . . . , λₙ are eigenvalues of covariance matrix K; and
∥⋅∥ is the Frombenius normalization.

Applying an upper bound of expression (4) with a target loss function in expression (3) may provide a simplified loss function L′ according to expression (5) as follows:

L′=∥K_{Z}_{_{B}}∥_{F}²+∥K_{Z}_{_{B}}∥_{F}²+∥K_{Z}_{_{A}}_{Z}_{_{B}}∥_{F}² (5)

Since Z_{A} and Z_{B} are assumed to be zero mean, a cross-covariance matrix K_{Z}_{_{A}}_{Z}_{_{B}} may reduce to a cross-correlation matrix R^{Z}^{_{A}}^{Z}^{_{B}}, assuming normalization without loss of generality. Similarly, auto-covariance matrices K_{Z}_{_{A}} and K_{Z}_{_{B}} may reduce to auto-correlation matrices R^{Z}^{_{A}} and R^{Z}^{_{B}}, respectively. According to an embodiment, matrices to express R^{Z}^{_{A}}^{Z}^{_{B}}, R^{Z}^{_{A}} and R^{Z}^{_{B}} may be minimized by driving diagonal terms to approach one, and all off-diagonal terms to approach zero. Accordingly, a resulting objective function L_{SSL}, may be set forth according to expression (6) as follows:

L_{SSL}=Σᵢ(1−Rᵢᵢ^{Z}^{_{A}})²+Σᵢ(1−Rᵢᵢ^{Z}^{_{B}})²+β₂Σᵢ(1−Rᵢᵢ^{Z}^{_{A}}^{Z}^{_{B}})²+v₁ΣᵢΣ_{j≠i}(Rᵢᵢ^{Z}^{_{A}})²+v₁ΣᵢΣ_{j≠i}(Rᵢᵢ^{Z}^{_{B}})²+μ₁ΣᵢΣ_{j≠i}(Rᵢᵢ^{Z}^{_{A}}^{Z}^{_{B}})² (6)

where μᵢ and vᵢ are hyper-parameters controlling diagonal and off-diagonal terms of corresponding matrices, and β₂ is a tunable parameter that may be determined holistically.

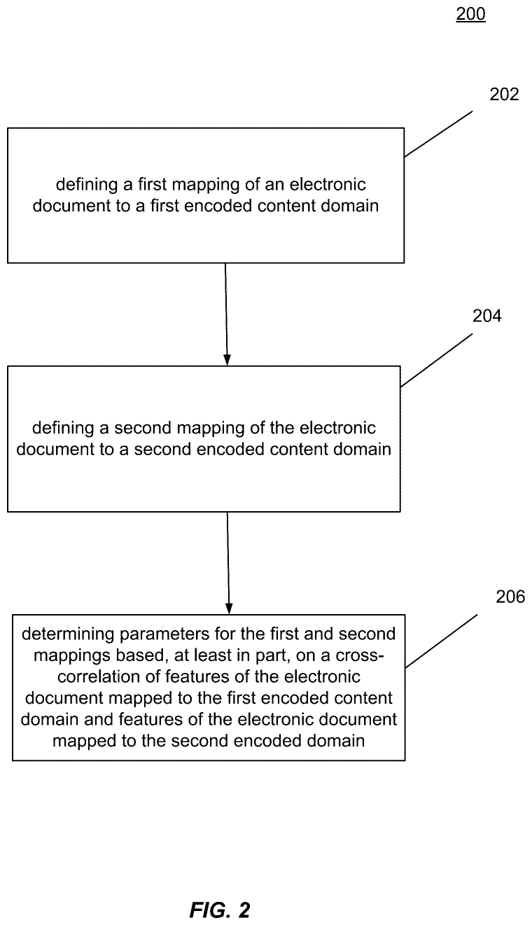

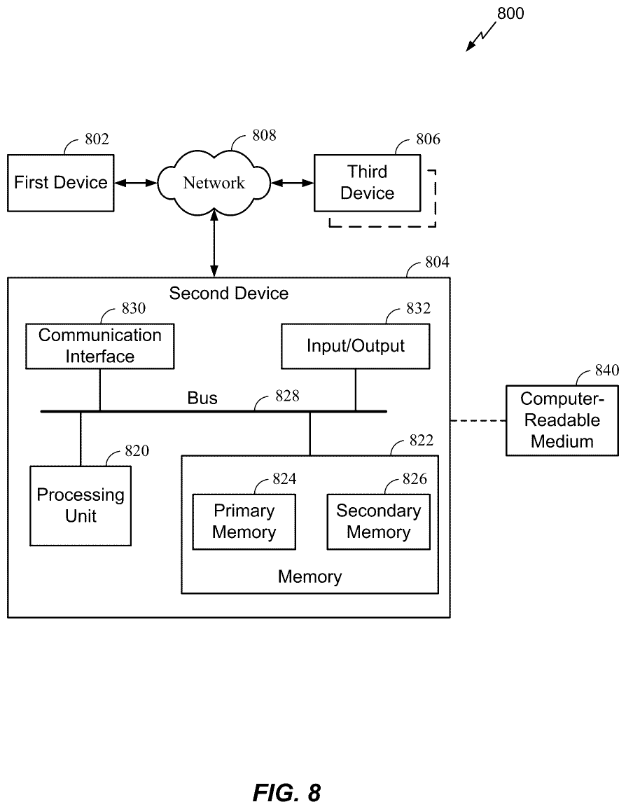

FIG. 2 is a flow diagram of a process 200 for determining parameters of mappings of features expressed in an electronic document to different content domains. In a particular implementation, process 200 may be performed, in whole or in part, by one or more computing devices such as computing devices as shown in FIG. 8, for example. Blocks 202 and 204 may comprise defining and/or executing different processing paths to be applied to parsed features of an electronic document. For example, block 202 may comprise defining and/or executing processing path processing patch sequence A in processing path 120 to generate encoded patch sequence A′ and/or Z_{A}.

Likewise, while block 204 may comprise processing patch sequence B in processing path 122 to generate encoded patch sequence B′ and/or Z_{B}. In the particular embodiment shown in FIG. 1, for example, a processing path defined and/or executed by block 202 may be tailored based on a function/mapping f_{T} while a processing path defined and/or executed by block 204 may be tailored based on a function/mapping [symbol] . Here, it should be recognized that function/mappings f_{T} and [symbol] are distinct from one another as discussed above.

Block 206 may comprise a determination of parameters that at least in part define first and second mappings defined and/or executed in blocks 204 and 206, respectively. In a particular example implementation, block 206 may comprise determining parameters for neural networks that implement processing paths 120 and 122. For example, block 206 may comprise determining weights and/or numerical coefficients of neural networks implementing encoders 110 and 116, and projectors 114 and 115. In a particular example implementation, training sets may be applied as electronic document 102 in associated training epochs for which system 100 may execute for determination of R^{Z}^{_{A}}, R^{Z}^{_{B}} and R^{Z}^{_{A}}^{Z}^{_{B}} for computation of a gradient of L_{SSL}. Block 206 may then determine weights and/or numerical coefficients of neural networks implementing encoders 110 and 116, and projectors 114 and 115 using iterations of backpropagation so as to minimize L_{SSL} based on the computed gradient, for example over multiple unlabeled training sets.

With an encoding of parsed content features to different encoded content domains in different processing paths 120 and 122, block 206 may enable SSL to converge to acceptably accurate and/or reliable results with fewer/smaller sample batches in training operations.

According to an embodiment, SSL may be employed in particular techniques such as masked image modeling (MIM) for implementation in computer vision applications. Such techniques may employ bidirectional encoder representations from transformers-related (BERT-related), BERT-related pre-training techniques for modeling language, for example. In particular implementations, an MIM technique may randomly mask patches of an input image and reconstruct image signal intensity values of pixel locations of masked patches with features of a subset of patches that are unmasked. Despite their performance on large downstream tasks (e.g., including image classification and object detection), techniques for learning object-wise visual representations from complex multi-object images (e.g., visually rich document images, structured table images, graphical user interface (GUI) images, and cardiac MRI) remain challenging. For example, an MIM technique may learn visual image semantics implicitly by reconstructing local patches. Application of contrastive learning, on the other hand, may enable learning of global features of augmented views. In other words, during operations to train an MIM, global features representing an entire image may not be learned.

According to an embodiment, incorporating global feature learning may be incorporated into an MIM framework using masked autoencoders (MAE) applying implicit constraints on a joint representation space. Taking advantage of such an implicit supervision of a reconstruction loss and a negative sample-free contrastive loss, an MIM technique may incorporate training model parameters to learn representations that recognize individual objects and relationships between and/or among objects in complex images. According to an embodiment, an SSL technique may apply a loss function incorporating multiple terms including one or more terms to implement contrastive learning. In a particular implementation, such techniques may yield acceptable results with fewer training epochs and/or over fewer training sets. This may result in a reduced use of computing resources to train parameters of an encoder and/or decoder to achieve an acceptable performance.

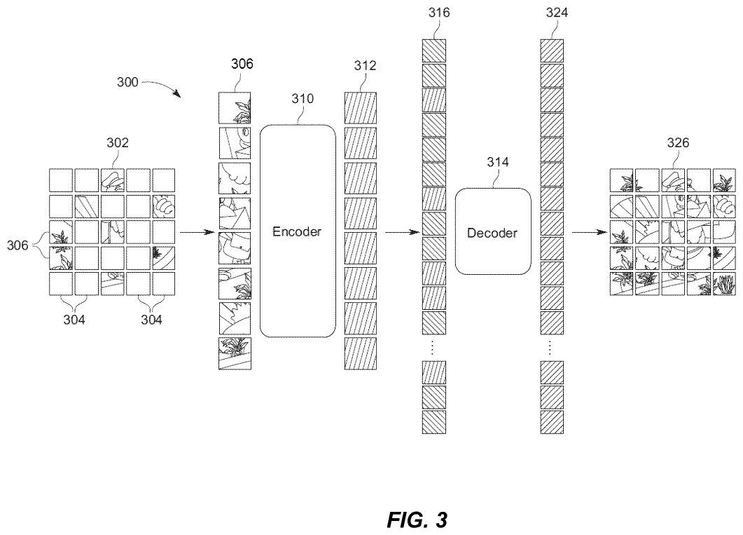

Process 300 of FIG. 3 illustrates one example technique for application of a MAE to an image 302 that is segmented into patches where patches 304 are masked and patches 306 remain unmasked. Unmasked patches 306 are to be encoded by encoder 310. Encoder 310 may apply any one of several encoding techniques to generate an encoded state 312. In one particular implementation, encoder 310 may apply one or more convolutional neural networks (CNNs) to produce encoded state 312 at an output layer, for example. In another particular implementation, encoder 310 may apply one or more so-called Vision Transformers (ViT) to provide encoded state 312 as described, for example, in K. He, X. Chen, S. Xie, Y. Li, P. Dollár, and R. Girshick, Masked Autoencoders are Scalable Vision Learners, Proceedings of Computer Vision and Pattern Recognition (CVPR 2022). IEEE, 2022 and/or A. Dosovitskiy, L. Beyer, A. Kolesnikov, D. Weissenborn, X. Zhai, T. Unterthiner, M. Dehghani, M. Minderer, G. Heigold, S. Gelly, J. Uszkoreit, and N. Houlsby, An Image is Worth 16×16 Words: Transformers for Image Recognition at Scale, 9th International Conference on Learning Representations (ICLR 2021), 2021 (hereinafter “He et al.”). It should be understood, however, that these are merely examples of techniques that may be applied to encode selected patches of an image to provide an encoded state, and claimed subject matter is not limited in this respect.

Encoded state 312 may be embedded with tokens to provide token-embedded encoded state 316. Such tokens may map associated encoded patches of encoded state to locations in image 302, for example. In one embodiment, patches in encoded state 312 may comprise compressed representations of corresponding unmasked patches 306. For example, an encoded patch in encoded state 312 may be derived from application of a compression operation (e.g., audio or image compression, including compression according to a standard technique such as H.25 X, MPEG or JPEG) to a corresponding unmasked patch. An embedded token in encoded state 312 may then reference the encoded patch to a location of the corresponding unmasked patch. In a particular implementation, token-embedded encoded state 316 may be transmitted to decoder 314 over a communication channel (e.g., in signal frames over a physical transmission medium in a communication network) or be stored in a memory device (not shown) to be retrieved for decoding by decoder 314. Here, decoder 314 may apply computing operations to token-embedded encoded state 316 (e.g., based, at least in part, on encoding operations applied by decoder 310) to provide a recovered/reconstructed image 326.

According to an embodiment, system 400 may expand MAE techniques by including a parallel branch and augmenting existing reconstruction objectives with a negative sample-free contrastive loss, L_{NSF}. For example, encoder 410 may transform view U (406) of content signal 402 to encoded state W_{U}, as encoder 310 may transform patches 306 to token-embedded encoded state 316. Additionally, encoder 416 of system 400 may transform view V (408) to encoded state W_{V}. Implementing parallel encoding/decoding branches 420 and 422 where concurrent reconstruction losses may be applied to branches 420 and 422 independently, system 400 may enable computation of at least a third loss term L_{NSF} to be applied jointly over a combination of branches 420 and 422.

In a particular implementation in which content signal 402 comprises an image (e.g., an image frame defining image signal intensity values associated with locations of pixels according to a pixel format) branch 420 may partition content signal 402 into multiple nonoverlapping visible patches (e.g., as in MAEs). In one embodiment, content signal 402 may be provided in the form of one or more electronic documents. In a linear projection, a significant portion of patches of an image (e.g., 75%) may be randomly masked. Remaining visible patches in view U at input signal 406, may be processed by an encoder 410 to obtain encoded state W_{U}. In particular implementations, W_{U} may be padded with mask tokens to produce a complete set of features. Patches in view of V at input signal 408 may be similarly processed by encoder 416 to obtain encoded state W_{V}.

While the above example is directed to input signal 406 (comprising view U) and input signal 408 (comprising view V) being patches of one or more images in content signal 402, in other embodiments views U and V may be of different content types. For example, view U may comprise patches of an image component of content signal 402 while view V may comprise an audio, text (or other natural language component), metadata, sensor observations/signals, etc. component of content signal 402. In other embodiments, both views U and V may be directed to components of content signal 402 that do not include image content (e.g., view U is directed to text (or other natural language expression) while view V is directed to audio content or sensor observations/signals). Particular implementations of branches 420 and 422 may be symmetric such that encoders 410 and 416 have identical structure, and decoders 414 and 415 have identical structure. Additional parameters (e.g., weights and/or coefficients for nodes of neural networks implementing branches 420 and 422) may be identical or different. In other implementations of branches 420 and 422 may be asymmetric such that encoders 410 and 416 have a different processing structure, and decoders 414 and 415 have a different processing structure. As such, particular implementations of branches 420 and 422 need not employ identical parameters, architecture or input modality, for example.

In this context, an “embedding” as referred to herein means an expression of a mapping of tokens to a collection of content features (e.g., patches), such as a mapping of such content features to particular positions and/or locations. In the particular implementation in which such content features comprise patches of an image, such a token may map such patches to locations in the image. Such a whole collection of features combined with positional embedding may be processed by a decoder (e.g., decoder 414 or 415). A decoded signal may then be linearly mapped to a pixel space to provide recovered view U′ at output signal 424 or recovered view V′ at output signal 426. Given a level of redundancy in images in content signal 402, it should be understood that a typical human may quickly recognize an image even with only partial observation of the image. Branch 422 may employ another view V of content signal 402 (e.g., according to a smudge transformation) that is different and distinct from a view of patches U of content signal 402.

According to an embodiment, input signals 406 and 408 to respective encoders 410 and 416 may be based on and/or extracted from different and distinct views of content signal 402. In one aspect, a “view” as referred to herein may refer to a projection of an aspect of a signal phenomenon onto a projection space. In a particular implementation, a view may comprise an image of one or more objects in a scene defined, at least in part, by a viewing location, range to the one or more objects and/or orientation of the one or more objects relative to the viewing location. In another particular implementation, a corresponding view of a content signal may comprise, for example, image frames capturing objects in a scene obtained from different viewing angles and/or different ranges, for example. In another particular implementation, corresponding views of a content signal may comprise results of different transformations applied to the same content signal. For a content signal comprising a pixelated image frame, for example, corresponding view may comprise results of different transformations applied to the pixelated image frame. Such different transformations applied to a pixelated image frame, transposition about an axis, blurring, distorting shapes of objects in the pixelated image frame, just to provide a few examples of a transformation that may be applied to a content signal to provide an associated view of the content signal. It should be understood, however, that these are merely examples of different views of a content signal may be obtained, and claimed subject matter is not limited in this respect. Additionally, a view of a content signal is not necessarily limited to an aspect of an image/image frame. For example, a view of a content signal may be directed to an aspect of other types of content components such as, for example, audio, text and/or other natural language expression. Here, such a view may be obtained from application of an augmentation such as increasing or decreasing a sample rate of an audio component of a content signal. For a view of a text or other natural language component of a content signal, a view may be obtained from replacing particular words with synonyms, or translating words or phrases to a different spoken/written language (e.g., translating words or phrases from English to Spanish).

According to an embodiment, encoder 410 and/or encoder 416 may implement one or more features to apply encoding operations to distinct views U and V of content signal 402 and provide encoded states W_{U} and W_{V}. In particular implementations, each of encoder 410 and 416 may comprise a ViT (e.g., as set forth in He et al.) and/or CNN to generate encoded states W_{U} and/or W_{V} based on views U and V of content signal 402. For example, aspects of views U and V (e.g., image signal intensity values of unmasked patches) may be provided as input signals to one or more neural networks forming encoder 410 and 416 to generate encoded states W_{U} and/or W_{V} as output tensors and/or predictions (e.g., output vectors) of the one or more neural networks.

According to an embodiment, parameters of an overall architecture (e.g., to include parameters of encoder 410, decoder 414, encoder 416 and decoder 415) may be determined in training epochs using backpropagation by applying a gradient of a loss function comprised of one or more reconstruction loss terms and a negative sample-free loss term together. Training epochs applying such a gradient of a loss function comprising one or more reconstruction loss terms and a negative sample-free loss term together may enable a simultaneous learning of fine-grained local features and global features, for example. A reconstruction loss (e.g., mean absolute error) may then be computed between original and reconstructed views U and U′ (also between original and reconstructed views V and V′) based solely on masked patches. Encoded states W_{U} and W_{V} may be condensed into global image features first to be used in computing L_{NSF}. In a particular implementation, encoded states W_{U} and W_{V} may be modeled as two jointly multivariate Gaussian variables with zero mean. Additionally, covariance matrices K_{U}∈ [symbol] ^{dxd} and K_{V}∈ [symbol] ^{dxd} of views U and V, respectively, may be full rank. As such, a negative sample-free contrastive loss L_{NSF} may be computed (e.g., based on reasoning shown above in expressions (1) through (6)) according to expression (8) as follows:

L_{NSF}=Σᵢ(1−Rᵢᵢ^{W}^{_{U}})²+Σᵢ(1−Rᵢᵢ^{W}^{_{V}})²+β₃Σᵢ(1−Rᵢᵢ^{W}^{_{U}}^{W}^{_{V}})²+v₂ΣᵢΣ_{j≠i}(Rᵢᵢ^{W}^{_{U}})²+v₂ΣᵢΣ_{j≠i}(Rᵢᵢ^{W}^{_{V}})²+μ₂ΣᵢΣ_{j≠i}(Rᵢᵢ^{W}^{_{U}}^{W}^{_{V}})² (8)

where:
v₂ and μ₂ are hyper-parameters controlling diagonal and off-diagonal terms of corresponding matrices; and
β₃ is a tunable parameter determined holistically.

A loss function Lₛₛₗ to be applied in machine learning operations to determine

parameters of encoder 410, decoder 414, encoder 416 and/or decoder 415 may be formulated to include a negative sample-free contrastive loss term (e.g., computed according to expression (8)) as shown in (9) as follows:

Lₛₛ=L_{rec}(U,U′)+L_{rec}(V,V′)+α₂L_{NSF} (9)

where:
α₂ is a hyper-parameter controlling a balance between objectives of loss

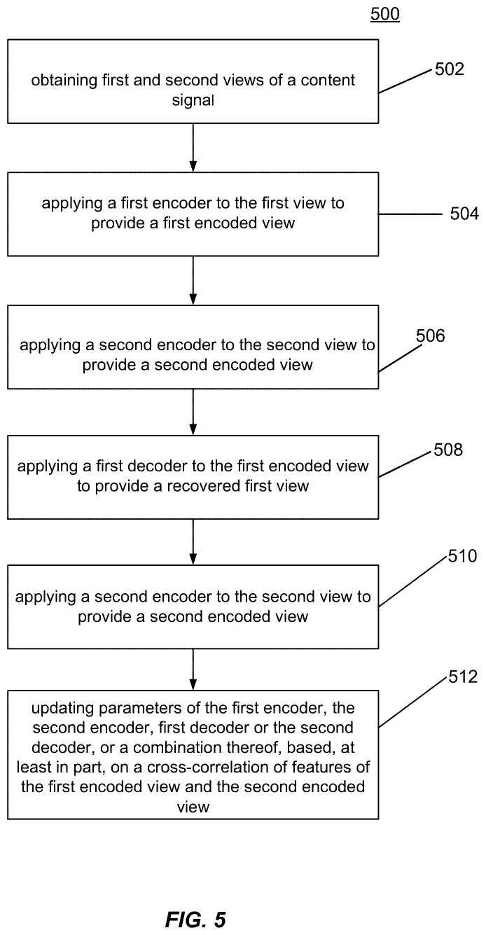

According to an embodiment, parameters defining features of a system and/or device to encode aspects of a content signal and/or decode such encoded aspects of a content signal may be determined using machine learning according to process 500 shown in FIG. 5. Process 500 may establish multiple training sets of a content signal to be applied in training operations. Such training sets may comprise, for example, one or more images. Such images may be expressed as image frames defining pixel locations and image signal intensity values associated with pixel locations (e.g., image signal intensity values for multiple color channels per pixel location). It should be understood, however, that this is merely example of content signal that may be provided as a training set, and claimed subject matter is not limited in this respect.

Block 502 may comprising obtaining views of a content signal of a training set such as, for example, distinct views U and V of content signal 402. In one example, a first view of a content signal obtained at block 502 may comprise an image frame. Encoder 410 at block 504 may process unmasked patches of such an image frame (e.g., provided as a first view) to compute an encoded state W_{U}. Similarly, encoder 416 at block 506 may process unmasked patches of such a different image frame (provided as a second view of a content signal obtained at block 502) to compute an encoded state W_{V}. Decoders 414 and 415 at blocks 508 and 510, respectively, may then decode encoded states W_{U} and W_{V} to provide a recovered first view and recovered second view, respectively. Block 512 may then update parameters of encoder 410, encoder 416, decoder 414 or decoder 415, or any combination thereof, based, at least in part on a cross-correlation of features of encoded states W_{U} and W_{V} (as incorporated in a loss function according to expression (9)). In the particular application of a loss function according to expressions (8) and (9), block 512 may further determine parameters of encoder 410, encoder 416, decoder 414 or decoder 415, or any combination thereof based, at least in part, on reconstruction losses based on differences between view U and reconstructed view U′ (L_{rec}(U,U′)) and/or based on differences between view V and reconstructed view V′ (Lrec(V,V′)). Such a reconstruction loss may be computed, for example as a means square error loss or mean absolute error loss, for example. As pointed out above, parameters to be updated at block 512 may comprise neural network weights, coefficients and/or other parameters to define encoder 410, encoder 416, decoder 414 or decoder 415, or a combination thereof.

In a particular implementation, block 512 may comprise updating parameters (e.g., neural network weights and/or coefficients) defining encoder 410, encoder 416, decoder 414 or decoder 415, or a combination thereof using back propagation based, at least in part, on a computed one or more gradients of a loss function (e.g., according to expressions (8) and/or (9)). Process 500 may be executed for multiple iterations/training epochs over multiple training sets. With use of a cross-correlation of features of encoded states W_{U} and W_{V}, block 512 may be capable of determining parameters of encoder 410, encoder 416, decoder 414 or decoder 415, or a combination thereof, to converge to acceptably accurate and/or reliable results with fewer/smaller sample batches.

In particular implementations, process 500 may provide certain advantages over other SSL approaches by learning better semantics and making training more efficient. For example, it can be shown that reconstruction loss components operating on a large percentage of invisible patches and contrastive loss components operating on a remaining smaller percentage of visible patches enables utilization of a larger portion of an image in training epochs. As such, use of contrastive loss components in a loss function employed in process 500 to train parameters of an encoder/decoder pair (e.g., weights of neural networks forming encoder 310 and decoder 314) may enable use of fewer training epochs (e.g., with fewer computing resources) to train the encoder/decoder pair to have a sufficient reconstruction accuracy.

One particular challenge in document processing relates to extracting tables and/or other structured objects for further analysis and/or processing. In practice, real-world table recognition scenarios (e.g., extracting tables from document images) may range from recognition in standard Word® and Latex documents to even more challenging electronic health records (EHR) and/or computer screen images. In particular scenarios, tables may be used to represent and communicate structured data in a wide range of document image types such as, for example, financial statements, scientific papers and electronic medical health documents, just to provide a few examples. Despite explosive growth in use of these types of document images, SSL approaches to processing such documents (e.g., feature detection and/or classification) have been limited to techniques applied in a natural image domain which may include, for example, application of detection models trained on human-labeled natural images.

Particular implementations described herein are directed to SSL approaches to document processing and/or analysis that consider particular tabular and/or structured document image domains. While table objects may provide a compact representation that a human can easily understand, recognizing and understanding table objects remains a challenge for machines since, unlike classic object detection classes, tables may have widely disparate sizes, types, styles and aspect ratios, for example. In other words, a table structure may vary greatly between document domains (e.g., Microsoft Word® vs graphical user interface (GUI) screenshot), and a large variety of table styles are feasible even within the same document format (e.g., borderless vs bordered).

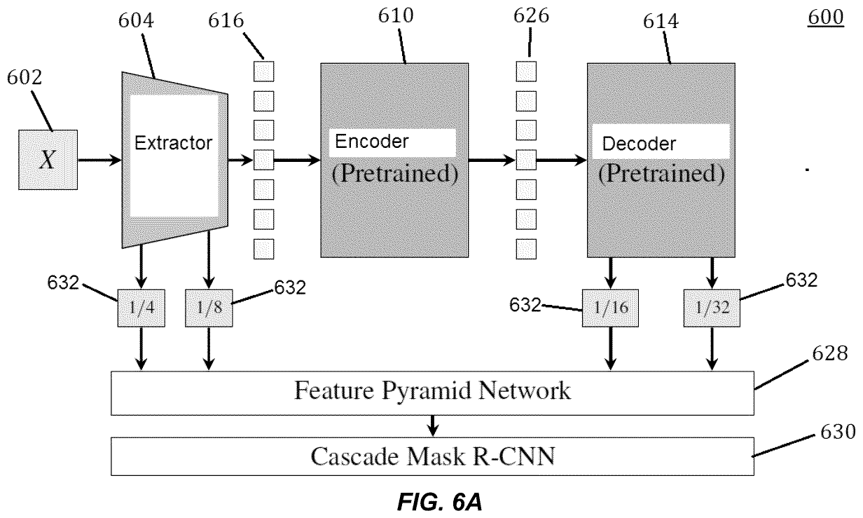

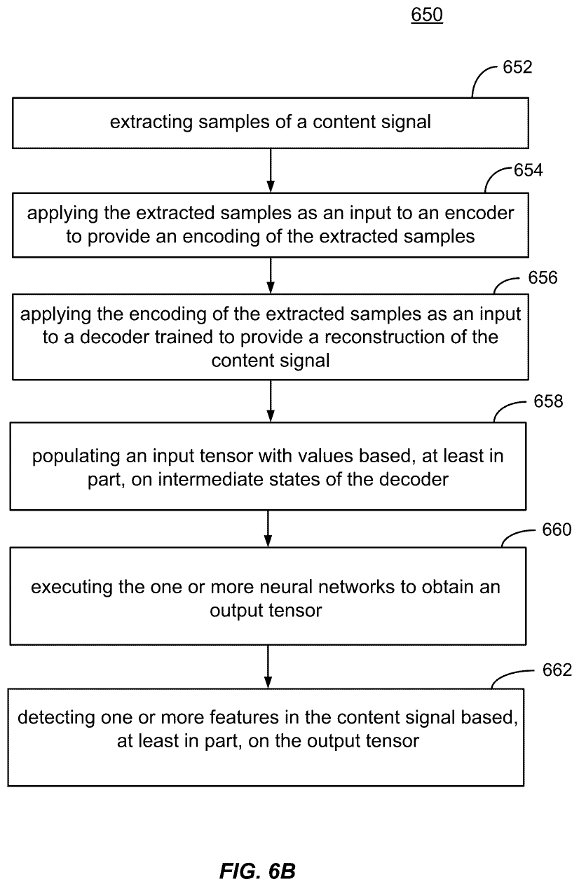

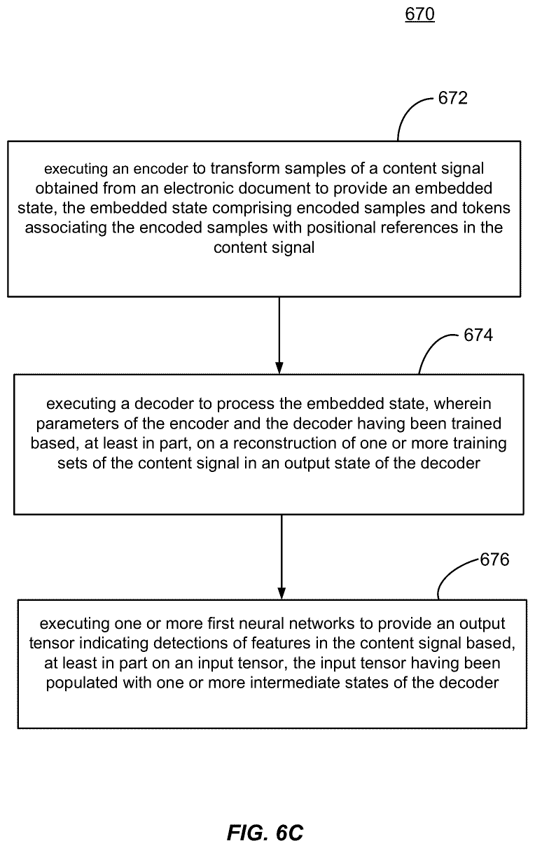

FIG. 6A is a schematic diagram of a system 600 to execute an additional embodiment of a technique for application of MAE to detection of objects in content signal 602 (e.g., an image). In a particular implementation, encoder 610 may be structured, at least in part, according to features of a ViT encoder (such as encoder 310) while decoder 614 may be structured, at least in part, according to features of a ViT decoder (e.g., decoder 314). Samples 616 (e.g., patches of an image) may be obtained from content signal 602 by extractor 604 where extractor 604 may replace a pre-trained process to segment an image into patches by implementing a hybrid multi scale feature extractor enabling a fine-tune a training operation with fewer training epochs. According to an embodiment, extractor 604 may configured as a so-called randomly initialed neat convolutional stem (ConvStem). One implementation of such a ConvStem may comprise a stacking of convolutions (e.g., 3×3 convolutions) with a stride of two and doubled feature dimensions as set forth in by Yuxin Fang, Shusheng Yang, Shijie Wang, Yixiao Ge, Ying Shan, Xinggag Wang, Unleashing Vanilla Vision Transformer with Masked Image Modeling for Object Detection, arXiv preprint, 19 May 2022. Such a ConvStem may comprise multiple convolutional neural network layers where each convolutional layer is followed by a layer normalization and a Gaussian error linear unit (GELU) activation, for example.

Like encoder 310, encoder 610 may apply any one of several encoding techniques to generate encoded state 626. For example, in training operations, decoder 614 may apply computing operations to token-embedded encoded state 626 (e.g., compressed patches in combination with tokens of localization information from encoding operations applied by encoder 610) to provide a recovered/reconstructed image (not shown). According to an embodiment, detection of objects in image 602 may be facilitated, at least in part, by a feature pyramid network 628 and/or cascade mask region-based CNN (R-CNN) 630. In one particular implementation, aspects of cascade mask R-CNN 630 may be as shown by Zhaowei Cai and Nuno Vasconcelos, “Cascade R-CNN: High Quality Object Detection and Instance Segmentation,” IEEE Transactions on Pattern Analysis and Machine Intelligence, 2019, ISSN 1939-3539.

According to an embodiment, feature pyramid network 628 may comprise a feature pyramid network (FPN) that may receive a single-scale image of an arbitrary size as an input (e.g., in an input tensor for a neural network), and output proportionally sized feature maps at multiple levels, in a fully convolutional fashion. In an implementation, such a process by an FPN may be applied independently of any particular backbone convolutional architecture. As such, an FPN may be applied as a generic solution for building feature pyramids within deep convolutional networks to be used in tasks like object detection. In a particular implementation, aspects of pyramid network 628 may be as shown by Tsung-Yi Lin, Piotr Dollar, Ross Girshick, Kaiming He, Bharath Hariharan and Serge Belongie, “Feature Pyramid Networks for Object Detection, arXiv:1612.03144v2, 19 Apr. 2017.

According to an embodiment, feature pyramid network 628 may comprise one or more neural networks to receive parameters and/or values from extractor 604 and/or decoder 614 formatted into one or more input tensors to be processed by feature pyramid network 628. Based, at least in part, on the one or more input tensors of the feature pyramid network 628, feature pyramid network 628 may compute one or more output tensors. An input tensor to one or more neural networks of cascade mask R-CNN 630 may be determined based, at least in part, on the one or more output tensors computed by feature pyramid network 628. According to an embodiment, an input tensor to a neural network of feature pyramid network 628 may be populated with tap values 632 which may be output signals from nodes of selected neural network layers of extractor 604 and decoder 614.

According to an embodiment, cascade mask R-CNN 630 may configure one or more detectors to solve a recognition problem to distinguish foreground objects from background and assigning the foreground objects object class labels, for example. Cascade mask R-CNN 630 may configure one or more detectors to solve a localization problem to, for example, define bounding boxes over different objects detected. Cascade mask R-CNN 630 may also configure one or more detectors to solve a classification problem to, for example, classify one or more objects detected to be within defined bounding boxes. In a particular implementation, parameters of detectors of cascade mask R-CNN 630 may be configured from one or more neural network layers that may be determined and/or tuned using training operations.

FIG. 6B is a flow diagram of a process 650 for detection and/or classification of features in a content signal according to an embodiment. Block 652 may comprise an extraction of samples of a content signal, such as content signal 602. For example, block 652 may comprise execution of extractor 604 to obtain samples of content signal 602 such as samples 616 which may comprise patches of an image of a document. Block 654 may comprise application of samples extracted at block 652 as an input to an encoder such as encoder 610 and execution of the encoder 610 to provide an encoded state (such as encoded state 626) as an input to decoder 614. Block 656 may comprise application of an encoding of samples extracted at block 652 as an input to a decoder (e.g., decoder 614) trained to provide a reconstruction of the content signal.

According to an embodiment, while a decoder (e.g., decoder 614) trained to provide a recovered content signal is executing, block 658 may populate an input tensor of one or more neural networks (e.g., one or more neural networks to implement feature pyramid 628 and/or cascade mask R-CNN 630) with values based at least in part, on intermediate states of the decoder. Such intermediate states may comprise, for example, output signals from nodes of selected neural network layers forming the decoder. Such selected neural network layers forming the decoder may precede an output layer that is to infer/predict reconstructed features of content signal 602. In another implementation, process 650 may further populate the one or more input tensors of the one or more neural networks with values based, at least in part, on intermediate states of an extractor that extracts samples at block 652 (e.g., output signals from nodes of selected neural network layers forming extractor 604). Block 660 may comprise executing one or more neural networks forming pyramid 628 and/or cascade mask R-CNN 630 to provide an output tensor. Block 662 may comprise detecting one or more features (e.g., objects) in a content signal samples at block 652 based, at least in part, on an output tensor provided at block 660.

FIG. 6C is a flow diagram of a process 670 to detect features in a content signal, according to an embodiment. In a particular implementation, process 670 may be executed, at least in part, by processing elements having parameters trained according to process 750, such as by system 600. Block 672 may comprise executing an encoder, such as encoder 610, to transform samples of a content signal obtained from an electronic document to provide an embedded state. Such a content signal may comprise, for example, an image signal, audio signal, linguistic symbols, just to provide a few examples. Such an embedded state may be derived, at least in part, from patches of the content signal that may be obtained by an extractor, such as extractor 604. According to an embodiment, such an embedded state may comprise encoded samples and tokens associating the encoded samples with positional references in the content signal. Such positional references may comprise, for example, a location within an image or other two-dimensional/three-dimensional content, time reference (e.g., in an audio signal) or position within a sequence of linguistic symbols, just to provide a few examples of a positional reference that may be expressed in a token associated with an encoded sample. In a particular implementation, such an embedded state may be expressed as signals and/or states stored in a memory, or symbols/values transmitted in a physical communication medium.

Block 674 may comprise executing a decoder, such as decoder 614, to process the embedded state provided at block 672. In a particular implementation, an encoder executed at block 672 and a decoder executed at block 674 may trained based, at least in part, on a reconstruction of content signal provided in an output state of the decoder. For example, parameters of such an encoder executed at block 672 and decoder executed at block 674 may be pretrained according to process 750. In a particular implementation in which an encoder executed at block 672 and decoder executed at block 674 comprise neural networks, such parameters may comprise neural network weights associated with nodes that are trained, at least in part, in a self-supervised training operation.

Block 676 may comprise executing one or more first neural networks to provide an output tensor indicating detections of features in the content signal based, at least in part on an input tensor. The one or more first neural networks may comprise neural networks such as feature pyramid network 628 and/or cascade mask R-CNN) 630, for example. The input tensor may be populated with one or more intermediate states of the decoder executed at block 674. In a particular implementation, such detections of features by the one or more first neural networks may comprise classifications and localizations of objects in an image. As discussed in particular examples below, a content signal obtained from an electronic document may comprise screen images and/or screenshots of electronic health records. Here, an output tensor of the one or more first neural networks executed at block 676 may comprise classifications of objects such as tables, table columns or graphical user interface (GUI) elements, and localizations such as locations of these objects in the images of the content signal.

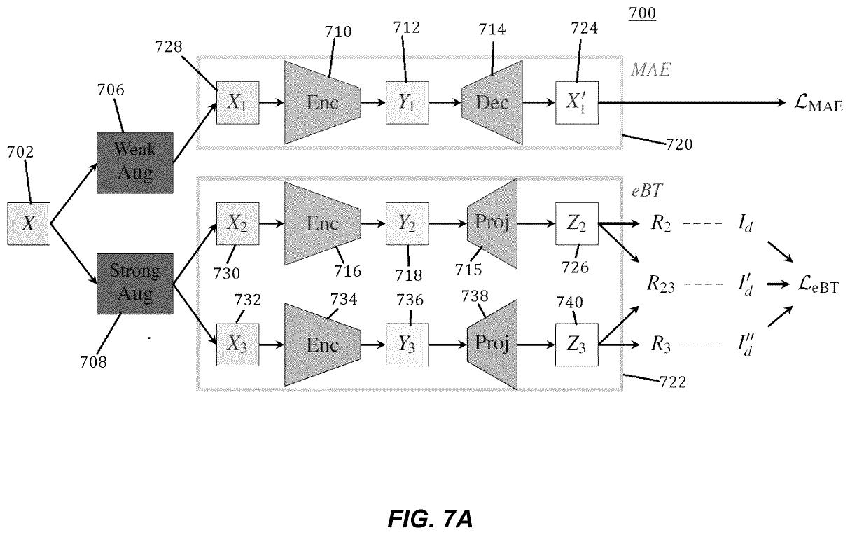

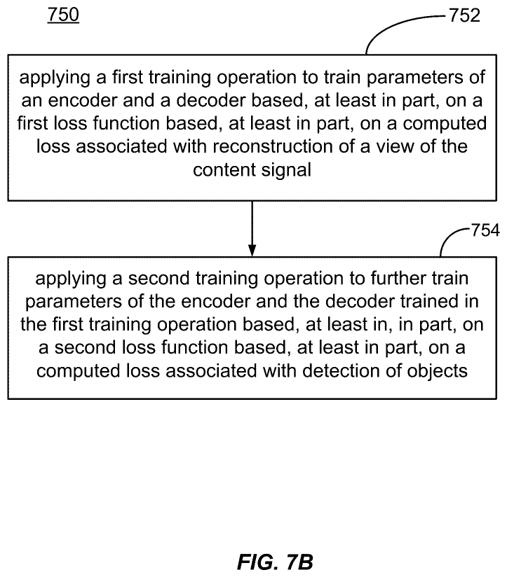

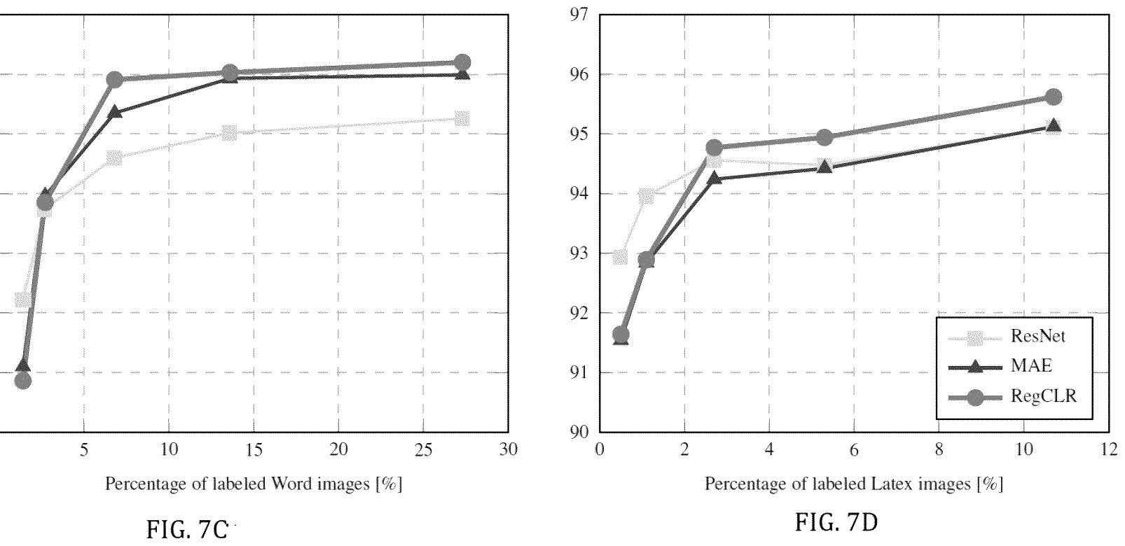

According to an embodiment, system 700 (FIG. 7A) may enable training operations to determine parameters of an encoder and/or decoder to implement MAE such as parameters of encoder 610 and decoder 614. Such parameters may comprise weights assigned to nodes in neural networks to implement encoder 610 and 614, for example. In particular, system 700 may define two branches directed to computing loss components originating from a reconstruction of a MAE encoder/decoder pair (branch 720) and from a contrastive aspect (e.g., according to an “enhanced Barlow Twins” model) (branch 722). In one implementation, such training operations may include updating parameters of encoder 610 and decoder 614 in iterations of backpropagation using a gradient of a loss function such as a loss function L_{c} according to expression (10) as follows:

L_{c}=L_{MAE}+L_{eBT}, (10)

where:
L_{MAE} is a reconstruction loss component based, at least in part, on view X₁ and a recovered view X₁′; and
L_{eBT} is a contrastive loss component based, at least in part, on projection 715 and 738 according to an enhanced Barlow Twins model.

In a particular implementation, L_{MAE} may be formulated to compute a mean squared error (MSE) between reconstructed and original images (e.g., between X₁ and recovered view X₁′) in an image pixel space. Such an MSE in an image pixel space may comprise an MSE in image signal intensity values of pixels between X₁ and recovered view X₁′. Computation of L_{MAE} may be limited to computation of an MSE over masked patches. It should be understood, however, that this is merely an example of how a reconstruction loss may be computed for L_{MAE} may be, computed the loss only on masked patches.

In the presently illustrated embodiment, X may comprise an input image where X₁,X₂,X₃ comprise augmented and/or varied views of input image X. For example, X₁ may be provided by application of a weak augmentation 706 to X such as, for example, a resizing (e.g., random resize cropping and/or such that a shortest side is between 480 and 800 pixels while a longest side is no more than 1333 pixels, or such that a shortest side is between 307 and 512 pixels and a longest side is no more than 853 pixels), random horizontal flipping and/or adaptive binarization. Additionally, X₂ and X₃ may be provided by application of a strong augmentation 708 to X such as, for example, a smudge transform and/or dilation (e.g., in addition to a resizing and/or adaptive binarization). According to an embodiment, different augmentation operations may be applied by strong augmentation 708 to provide corresponding different and distinct augmentations X₂ and X₃.

Encoded states Y₁,Y₂,Y₃ may comprise corresponding hidden/latent representations. In one aspect, an ideal and/or best representation Y may retain as much information about input image X as possible with a given representation constraint such as, for example, an information bottleneck (IB) framework set forth by Noam Slonim, Nir Friedman, and Naftali Tishby, “Multivariate Information Bottleneck,” Neural Computation, 18(8):1739-1789, Aug. 2006. As pointed out above, encoded states Y₁,Y₂,Y₃ may comprise token-embedded encoded states where tokens associate patches (e.g., patches based on a compression operation applied to patches in X) with locations in an image (e.g., an image of X) in some manner. In one application of such an IB framework, n may denote a number of samples, d may denote a feature dimension, and Z₂,Z₃∈R^{nxd} may denote projected features. In one aspect, Z₂ and Z₃ may be modeled at least in part as two jointly multivariate Gaussian variables with zero means and respective covariance matrices K₂, K₃∈R^{dxd} of Z₂, Z₃ that are full rank. Correlation matrices for Z₂ and Z₃ may be provided by application of a projection 715 and/or 738 to encoded states Y₂ and Y₃. Projection 715 and/or 738 may be implemented, for example, as a two-layer/multi-layer perceptron with a 1024 dimensional output, for example. It should be understood, however, that this is merely an example of how projection 715 and/or 738 may be implemented, and claimed subject matter is not limited in this respect. In one particular implementation, projections 715 and 738 may comprise identical operations to map encoded states Y₂ and Y₃ to the same vector space as Z₂ and Z₃, respectively. In another implementation, projections 715 and 738 may comprise different operations to map encoded states Y₂ and Y₃ to different vector spaces.

In one implementation, a constraint according to an IB framework may compress view X₂ into Z₂ while preserving the information regarding Z₃. Similarly, such a constraint may compress view X₃ into Z₃ while preserving information regarding Z₂. In other words, X₂ and X₃ may be compressed as much as possible subject to a constraint according to an IB framework while also making Z₂ and Z₃ as informative about one another as possible. In one example, such a constraint may be set forth, at least in part, by θ in expression (11) as follows:

$${arg max}_{θ} [ I ( {X}_{1} ; {Y}_{1} \vert θ ) - I ( {Z}_{2} ; {X}_{2} \vert θ ) - I ( {Z}_{3} ; {X}_{3} \vert θ ) + {α}_{3} I ( {Z}_{2} ; {Z}_{3} \vert θ ) ] \qquad ( 11 )$$

According to an embodiment, branch 720 may apply a relatively weak augmentation at block 706 and masking to obtain recovered view X₁, and then follow a procedure introduced in MAE to compute a reconstructed loss for unmasked patches as L_{MAE} to obtain X₁′. Branch 722, on the other hand, may apply a relatively strong augmentation at block 708 applied twice to provide views X₂ and X₃. In one embodiment, encoders 710, 716 and 734 may comprise identical ViT encoders for use in providing a recovered view in branch 720 and in providing projected feature of views X₂ and X₃ as Z₂ and Z₃, respectively, in branch 722. In other embodiments, encoders 710, 716 and 734 may have different processing structures (e.g., neural networks with different topologies) and/or processing structures with different tunable parameters (e.g., neural network weights). In an embodiment, Z₂ and Z₃ may be expressed as correlation matrices computed to approach identity matrices.

In a particular implementation, loss function L_{c} according to expression (10) may be modeled according to expression (12) as follows:

L_{c}=L₁+L₂, (12)

where:
L₁=h(X₁|Y₁);
L₂=(1−α₃)h(Z₂)+(1−α₃)h(Z₃)+α₃h(Z₂, Z₃);
α₃ is a tunable parameter; and
h( ) is an entropy function.

As may be observed from expression (10), h(X₁) may be constant while an input distribution is fixed and h(Z₂, X₂)=h(Z₃, X₃)=0. It may be observed that minimizing an expected reconstruction error may equate to maximizing a lower bound on loss term L₁ in expression (10). This may hold true even if Y is a function of a corrupted input (e.g., masked out image). Therefore, for example, a mean squared error (MSE) between an augmented the augmented image X₁ and a reconstructed version X₁′ (as L_{MAE}) may be considered to be an equivalent of loss term L₁. Remaining components of loss term L₂ in expression (12) may be expressed according to expression (13) as follows:

L₂→log (|K₂|)+log (|K₃|)+β₄ log (|K₂₃|), (13)

where

$${β}_{4} {=}^{△} ( \frac{{α}_{3}}{1 - {α}_{3}} ) ,$$

K₂ is a covariance matrix for Z₂, K₃ is a covariance matrix for Z₃ and K₂₃ is a cross-covariance matrix for Z₂and Z₃. An upper bound may be applied according to expression (14) as follows:

log (|K|)=log (Πᵢ₌₁ⁿλᵢ)=Σᵢ₌₁ⁿ log λᵢ<Σᵢ₌₁ⁿλᵢ²=∥K∥_{F}². (14)

Combining expressions (13) and (14), loss term L₂ may be further simplified according to expression (15) as follows:

L₂→∥K₂∥_{F}²+∥K₃∥_{F}²+β∥K₂₃∥_{F}² (15)

Assuming Z₂ and Z₃ are at least approximately zero mean, covariance matrix K₂₃ may be computed as a cross-correlation matrix R₂₃. Similarly, covariance matrices K₂ and K₃ may be computed as correlation matrices R₂ and R₃, respectively. Since a solution of zero matrices may be trivial in minimizing expression (15), such a solution may be circumvented by urging diagonal terms to be one and off-diagonal terms to be zero to simplify loss term L₂ to provide a loss function component according to expression (16) as follows:

L_{eBT}=v₃₁Σᵢ(1−R_{2,ii})²+v₃₁Σᵢ(1−R_{3,ii})²+v₃₂Σᵢ(1−R_{23,ii})²+μ₃₁ΣᵢΣ_{j≠i}(R_{3,ij})²+μ₃₂ΣᵢΣ_{j≠i}(R_{3,ij})² (16)

where v₃₁, v₃₂, μ₃₁ and μ₃₂ are hyperparameters for controlling diagonal and off-diagonal terms of corresponding matrices. In one implementation, values of v₃₁=0.00255, v₃₂=0.0051, μ₃₁=0.5 and μ₃₂=1.0 may be used to balance between auto-correlation and cross-correlation terms during training.

According to an embodiment, application of L_{eBT} as L₂ may provide an architecture that incorporates a combination of contrastive learning (by use of L_{eBT} expression (16)) and regularized self-supervised learning (SSL) (e.g., with implementation of L_{MAE}) to achieve improvement in training computing devices for both detection and classification of objects.

FIG. 7B is a flow diagram of a process 750 to determine parameters of an encoder and decoder such as, for example, an encoder 610 and 614 shown in FIG. 6A, using a self-supervised pretraining operation applied to training sets of a content signal (e.g., content signal 702). In a particular implementation, features of process 750 may be executed by system 700 (FIG. 7A). In one aspect, such self-supervised training operations may comprise computation of a loss function to be applied in updating parameters of an encoder/decoder pair, such as a loss function set forth according to expression (10) or expression (11). Block 752 may comprise application of a self-supervised operation to train parameters of an encoder and a decoder based, at least in part, on a first loss function such as a loss function set forth in expressions (10) and/or (12). Block 752 may comprise computing such a first loss function to include a first term a loss function to model a reconstruction loss such as a term L_{MAE} and/or L₁. Block 754 may also comprise computing a second term of a loss function such as a second term of a loss function to model a contrastive loss such as a term L_{eBT} and/or L₂ according to expressions (12), (14) and/or (15), for example. Block 752 may further comprise updating parameters of encoder 610 and decoder 614 based, at least in part, on back propagation applied to a gradient of a computed loss function (e.g., L_{c}).

According to an embodiment, block 752 may comprise an initial “coarse” training of parameters of an encoder and decoder such as encoder 610 and decoder 614. Block 754 may comprise a subsequent “fine” training such as a loss function set forth in expression (10) or expression (11) having term computed at blocks 752 and 754. In such a fine training at block 754, labeled training sets may be applied to update/train parameters of encoder 610 and decoder 614, in addition to parameters of extractor 604, feature pyramid network 628 and/or cascade mask R-CNN 630. In an iteration/training epoch of such a fine training stage at block 754, a second loss function may be defined based, at least in part, on a comparison of labels associated with a training input from content signal 602 and a resulting inference generated by cascade mask R-CNN 630 in the localization and/or classification of objects. According to an embodiment, fine training stage at block 754 may be based on a loss function incorporating a localization loss component (L_{loc}) and a classification loss component (L_{cls}) according to expression (17) as follows:

L=L_{loc}+L_{cls} (17)

Location loss component L_{loc} may be computed based, at least in part, on inferred positions of detected objects within associated bounding boxes. Classification loss component L_{cls} may be computed based, at least in part, on an inferred classification of objects detected to be located within bounding boxes. In a particular implementation, location loss component L_{loc} and classification loss component L_{cls} may be computed using techniques and methodologies shown by Lilian Weng, “Object Detection for Dummies Part 3: R-CNN Family,” Lil'Log, github, 17 Dec. 2017 and Lilian Weng, “Object Detection Part 4: Detection Models,” Lil'Log, github, 27 Dec. 2018. It should be understood, however, that these are merely examples of how a localization loss and a classification loss may be computed, and claimed subject matter is not limited in this respect.

In iterations of a fine training stage at block 754, parameters of encoder 610 and decoder 614, in addition to parameters of extractor 604, feature pyramid network 628 and/or cascade mask R-CNN 630 (e.g., neural network weights, coefficients and/or other neural network parameters) may be updated using backpropagation based, at least in part, on one or more computed gradients of the second loss function computed according to expression (17), for example.

According to an embodiment, block 752 may execute a first training operation to determine parameters of an encoder (such as an instance of encoder 610) to transform samples of a content signal obtained from an electronic document to an embedded state, and to determine parameters of a decoder (such as an instance of decoder 614) to transform the embedded state to a reconstruction of at least a portion of the content signal. The embedded state may comprise encoded samples of the content signal and tokens associating the encoded samples with positional references in the content signal. Following a first training operation at block 752, block 754 may execute a second training operation to determine parameters of one or more first neural networks to detect features in the content signal based, at least in part, on an input tensor populated with intermediate states of the decoder.

According to an embodiment, a first training operation at block 752 may comprise: computing a first term of a first loss function based, at least in part, on a reconstruction loss and a contrastive loss (e.g., according to expression (10)). Parameters of the encoder and decoder may then be based, at least in part, on a gradient of the first loss function in a backpropagation process. In an implementation, such a contrastive loss may comprise applying of an instance of the decoder to multiple distinct views of a training set content signal to provide multiple encoded views; and computing a cross-correlation of projections of at least two of the encoded views, for example.

According to an embodiment, the second training operation at block 754 may further comprise: executing the one or more first neural networks to compute an inference; and computing a loss function based, at least in part, on the computed inference. Such a loss function applied at block 754 may comprise at least a localization loss term and a classification loss term (e.g., as shown in expression (17)). In a particular implementation, such a localization loss term may be based, at least in part, on an inferred localization of detected objects within one or more bounding boxes defined in an image. Such a classification loss term may be based, at least in part, on an inferred classification of the detected objects.

According to an embodiment, a second training operation at block 754 may further comprise determining parameters of an extractor (e.g., an instance of extractor 604) to map the content signal to the samples of the content signal. Such the parameters of the extractor comprise parameters of one or more second neural networks. In a particular implementation, the input tensor of the one or more first neural networks may be further populated with intermediate states of the one or more second neural networks.

It should be appreciated that embodiments of an approach to training system 600 using a coarse SSL training stage followed by a finer training stage with labeled data sets (e.g., according to process 750) have shown superior performance over techniques to train such a computing device using merely an SSL training stage or merely a supervised training stage (with labeled data sets). This has been demonstrated using a TableBank dataset and an EHRBank dataset. TableBank dataset comprises a publicly available image-based table dataset for Word® and Latex containing 417K high-quality tables labeled with a weak supervision split across Word® and Latex sets (with a Word document sets containing English, Chinese, Japanese, Arabic, and other languages, while areas the Latex document set is primarily in English. EHRBank Dataset comprises a systematically curated dataset of screen images from real-world electronic health record (EHR) systems, which consists of screenshots collected by bots as they navigate EHR systems of ten US health systems from various EHR providers. Particular screens may then be selected to include essential template screens and labeled by an internal team of labelers, including tables, table columns, and other graphical user interface (GUI) elements. Details of TableBank dataset and an EHRBank dataset composition are summarized in Table 1 below. It is noted that that the unlabeled EHRBank Screenshot dataset (shown in the last row) was used only for an initial coarse training.

TABLE 1

| | Train | Val | Test |
|---|---|---|---|
| TableBank Word | 73,383 | 2,735 | 2,281 |
| TableBank Latex | 187,199 | 7,265 | 5,719 |
| EHRBank Table | 1,917 | 411 | 209 |
| EHRBank Column | 1,194 | 255 | 208 |
| EHRBank GUI | 157 | 38 | 157 |
| EHRBank Screenshot (unlabeled) | 28,121 | | |

For the EHRBank Column dataset, images were further cropped to just tables, removing examples that were occluded from overlays. In addition to the aforementioned supervised dataset with labeled objects, an unlabeled screenshot dataset was collected from records and video recordings of hospital staff interacting with an EHR system. Randomly sampled frames were obtained from screen recordings randomly sampled from the database. Randomly sampled frames were split into two parts to account for staff members having a dual monitor set up. Randomly sampled frames without tables or columns, and sampled frames corrupted due to the splitting process, were removed to provide a dataset containing 28,121 PNG images of resolution of 1920×1080, which corresponds with 10.8% of the volume of the TableBank dataset.

Results for table detection on the TableBank dataset for detection average-precision (AP) are shown in FIGS. 7C and 7D and in Table 2 below wherein MAE denotes a purely self-supervised training, ResNet denotes a purely supervised training (e.g., with labeled training sets) and REGCLR denotes a self-supervised coarse training stage followed by a smaller supervised fine training stage. FIG. 7C shows training performance for a Word® set while FIG. 7D shows training performance for a Latex set. Each datapoint in graphs of FIGS. 7C and 7D represent a number of labeled subsets of 1 k, 2k, 5k, 10k, and 20k sizes. As may be observed, REGCLR appears to begin to perform particularly well after a 2-3% subset of labeled train data is provided for a fine training stage.

It may be observed that REGCLR may perform particularly well for pretraining with the EHRBank Screenshot dataset, increasing AP scores relatively by 4.8% for detection of table objects and 11.8% for column over the ResNET supervised baseline, as seen by comparing the first and second rows of Table 3 below. Despite an initial coarse training stage with approximately 10% volumes of TableBank, REGCLR was shown to fast approach the best cross-domain transfer results from TableBank to EHRBank in the last row of Table 3.

TABLE 3

| | | Table | | Column | |
|---|---|---|---|---|---|
| Pretrain on | Method | AP | AP₇₅ | AP | AP₇₅ |
| N/A | ResNet | 40.53 | 44.46 | 61.43 | 67.07 |
| EHRBank Screenshot | REGCLR | 42.46 | 45.32 | 68.68 | 75.17 |
| | MAE | 36.78 | 39.05 | 64.67 | 71.09 |
| TableBank | REGCLR | 40.96 | 43.47 | 67.77 | 75.06 |
| (cross-domain) | MAE | 43.99 | 48.77 | 69.83 | 77.29 |

Results of detection of GUI elements in an EHRBank GUI test set based on detection AP and AP₇₅ are summarized in Table 4 below, while results of detection of GUI elements based on detection AP for individual GUI elements is shown in Table 5 below (where AP₇₅ is a precision evaluated at a 75% intersection-over-union (IoU) threshold). As may be observed, REGCLR appears to outperform baselines in both AP and AP₇₅. Specifically, REGCLR appears to outperform baselines in eight of twelve categories while MAE appears to perform even worse than ResNet in six.

TABLE 4

| | ResNet | MAE | RegCLR |
|---|---|---|---|
| AP | 43.37 | 45.69 | 48.17 |
| AP₇₅ | 48.25 | 50.80 | 54.10 |

TABLE 5

| | ResNet | MAE | REGCLR |
|---|---|---|---|
| Button | 38.42 | 33.02 | 33.13 |
| Dropdown | 48.02 | 44.33 | 43.14 |
| Dropdown_group | 43.25 | 41.71 | 43.33 |
| Horizontal_scrollbar | 25.12 | 36.88 | 38.78 |
| Overlay | 52.92 | 65.58 | 62.12 |
| Tab | 37.62 | 34.13 | 36.46 |
| Tab_group | 29.94 | 30.35 | 32.77 |
| Table | 62.72 | 66.10 | 72.64 |
| Table_column | 46.31 | 50.44 | 54.74 |
| Text_box | 55.03 | 54.56 | 58.06 |
| Text input_group | 42.82 | 41.38 | 44.87 |
| Vertical_scrollbar | 37.28 | 47.32 | 52.00 |

Test sets were evaluated for REGCLR applied to the subsets of 1k, 2k, 5k, 10k, and 20k sizes. In the present experiment, 10,000 iterations with a batch size of 12 were used. As shown in FIGS. 7C and 7D, REGCLR outperformed baselines soon after fine training stage on a subset of 2-3% labeled training set, with AP scores improving quickly even with considerably fewer labeled images (i.e., less than 10%) provided than the unlabeled set. Also, incremental gains are shown to decrease as more labeled data sets are added.

For the EHRBank dataset, REGCLR was evaluated on internal EHRBank dataset. As shown in Table 3, when pretrained on unlabeled EHRBank, REGCLR outperforms baselines in both Table and Column detection, increasing relative AP scores by 4.8% and 11.8% respectively over the ResNET baseline, as seen by comparing the first and second rows of Table 3. Furthermore, even though pretrained with only around 10% of TableBank volume, REGCLR is shown to quickly approach a best cross-domain transfer performance from TableBank to EHRBank, as shown in the last row of Table 3. Additionally, it may be observed that MAE is shown to perform worse than even ResNet on Table 3 when pretrained on EHRBank (by comparing the first and third rows). MAE may, however, transfer better than REGCLR in scenarios involving cross-domain transfer from public TableBank to private EHRBank (by comparing the last two rows of Table 3). Table 5 presents results for detection of GUI elements detection, for which a coarse stage training for REGCLR was based on EHRBank Screenshot again produces the highest overall detection scores compared to baselines. As such, it may be observed that REGCLR may improve performance even in more complicated scenarios with a larger number of classes and possible occlusions between different GUI elements. Performance variation across different

GUI categories is also presented in Table 5.

In the context of the present patent application, the term “connection,” the term “component” and/or similar terms are intended to be physical but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the terms “entry,” “electronic entry,” “document,” “electronic document,” “content”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public. According to an embodiment, a signal packet and/or frame may comprise all or a portion of a “message” transmitted between devices. In an implementation, a message may comprise signals and/or states expressing content to be delivered to a recipient device. For example, a message may at least in part comprise a physical signal in a transmission medium that is modulated by content that is to be stored in a non-transitory storage medium at a recipient device, and subsequently processed.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

In one example embodiment, as shown in FIG. 8, a system embodiment may comprise a local network (e.g., device 804 and medium 840) and/or another type of network, such as a computing and/or communications network. For purposes of illustration, therefore, FIG. 8 shows an embodiment 800 of a system that may be employed to implement either type or both types of networks. Network 808 may comprise one or more network connections, links, processes, services, applications, and/or resources to facilitate and/or support communications, such as an exchange of communication signals, for example, between a computing device, such as 802, and another computing device, such as 806, which may, for example, comprise one or more client computing devices and/or one or more server computing device. By way of example, but not limitation, network 808 may comprise wireless and/or wired communication links, telephone and/or telecommunications systems, Wi-Fi networks, Wi-MAX networks, the Internet, a local area network (LAN), a wide area network (WAN), or any combinations thereof.

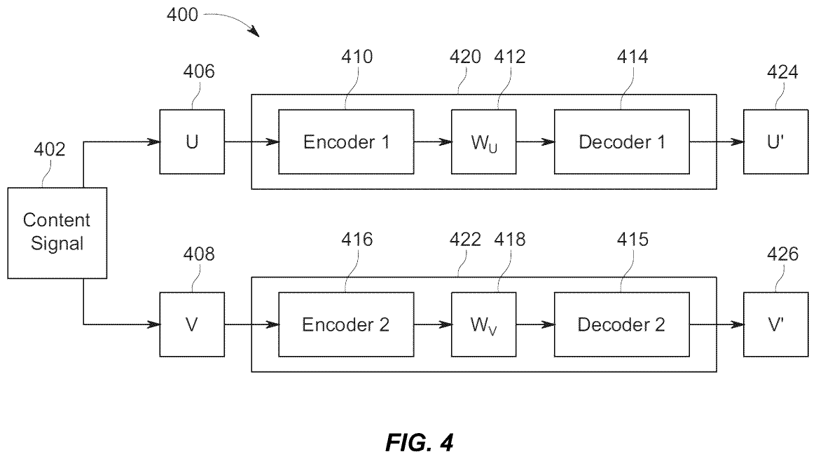

Example devices in FIG. 8 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU) and/or neural network processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1 through 5, 6A, 6B, 6C, 7A and 7B, and in the text associated with the foregoing figure(s) of the present patent application.

Referring now to FIG. 8, in an embodiment, first and third devices 802 and 806 may be capable of rendering a graphical user interface (GUI) for a network device and/or a computing device, for example, so that a user-operator may engage in system use. Device 804 may potentially serve a similar function in this illustration. Likewise, computing device 802 (‘first device’ in figure) may interface with computing device 804 (‘second device’ in figure), which may, for example, also comprise features of a client computing device and/or a server computing device, in an embodiment. Processor (e.g., processing device) 820 and memory 822, which may comprise primary memory 824 and secondary memory 826, may communicate by way of a communication bus 815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 804, as depicted in FIG. 8, is merely one example, and claimed subject matter is not limited in scope to this particular example. FIG. 8 may further comprise a communication interface 830 which may comprise circuitry and/or devices to facilitate transmission of messages between second device 804 and first device 802 and/or third device 806 in a physical transmission medium over network 808 using one or more network communication techniques identified herein, for example. In a particular implementation, communication interface 830 may comprise a transmitter device including devices and/or circuitry to modulate a physical signal in physical transmission medium according to a particular communication format based, at least in part, on a message that is intended for receipt by one or more recipient devices. Similarly, communication interface 830 may comprise a receiver device comprising devices and/or circuitry demodulate a physical signal in a physical transmission medium to, at least in part, recover at least a portion of a message used to modulate the physical signal according to a particular communication format. In a particular implementation, communication interface may comprise a transceiver device having circuitry to implement a receiver device and transmitter device.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, GNSS receiver and/or other location-identifying type capability, and/or a display with a higher degree of functionality, such as a touch-sensitive color 5D or 3D display, for example.

In FIG. 8, computing device 802 may provide one or more sources of executable computer instructions in the form physical states and/or signals (e.g., stored in memory states), for example. Computing device 802 may communicate with computing device 804 by way of a network connection, such as via network 808, for example. As previously mentioned, a connection, while physical, may not necessarily be tangible. Although computing device 804 of FIG. 8 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 822 may comprise any non-transitory storage mechanism. Memory 822 may comprise, for example, primary memory 824 and secondary memory 826, additional memory circuits, mechanisms, or combinations thereof may be used. Memory 822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 822 may be utilized to store a program of executable computer instructions. For example, processor 820 may fetch executable instructions from memory and proceed to execute the fetched instructions. Memory 822 may also comprise a memory controller for accessing device readable-medium 840 that may carry and/or make accessible digital content, which may include code, and/or instructions, for example, executable by processor 820 and/or some other device, such as a controller, as one example, capable of executing computer instructions, for example. Under direction of processor 820, a non-transitory memory, such as memory cells storing physical states (e.g., memory states), comprising, for example, a program of executable computer instructions, may be executed by processor 820 and able to generate signals to be communicated via a network, for example, as previously described. Generated signals may also be stored in memory, also previously suggested.

Memory 822 may store electronic files and/or electronic documents, such as relating to one or more users, and may also comprise a computer-readable medium that may carry and/or make accessible content, including code and/or instructions, for example, executable by processor 820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, samples, observations, weights, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 8, processor 820 may comprise one or more circuits, such as digital circuits, to perform at least a portion of a computing procedure and/or process. By way of example, but not limitation, processor 820 may comprise one or more processors, such as controllers, microprocessors, microcontrollers, application specific integrated circuits, digital signal processors (DSPs), graphics processing units (GPUs), neural network processing units (NPUs), programmable logic devices, field programmable gate arrays, the like, or any combination thereof. In various implementations and/or embodiments, processor 820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 8 also illustrates device 804 as including a component 832 operable with input/output devices, for example, so that signals and/or states may be appropriately communicated between devices, such as device 804 and an input device and/or device 804 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

According to an embodiment, a neural network may comprise a graph comprising nodes to model neurons in a brain. In this context, a “neural network” as referred to herein means an architecture of a processing device defined and/or represented by a graph including nodes to represent neurons that process input signals to generate output signals, and edges connecting the nodes to represent input and/or output signal paths between and/or among neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices including a central processing unit (CPU), graphics processing unit (GPU), digital signal processing (DSP) unit and/or neural processing unit (NPU), just to provide a few examples. In a particular implementation, neural network weights and/or numerical coefficients associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neuron may apply a neural network weight to input signals, and sum weighted input signals to generate a linear combination.

According to an embodiment, edges in a neural network connecting nodes may model synapses capable of transmitting signals (e.g., represented by real number values) between neurons. Responsive to receipt of such a signal, a node/neural may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In an implementation, transmission of an output signal from a node in a neural network may be inhibited if a strength of the output signal does not exceed a threshold value.

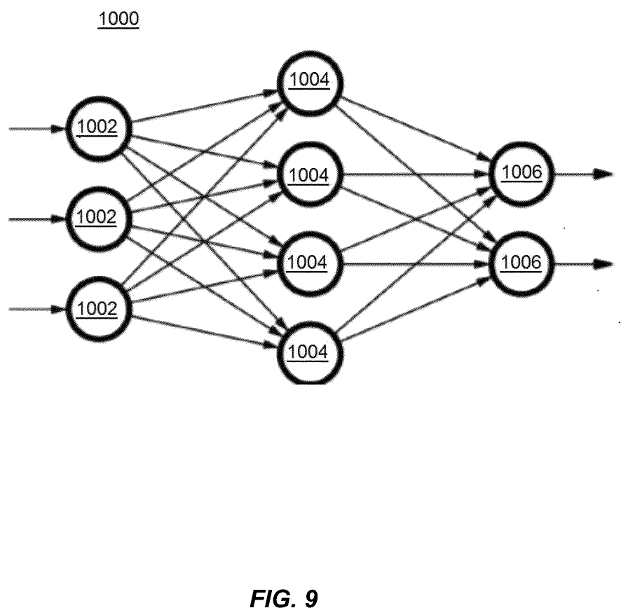

FIG. 9 is a schematic diagram of a neural network 1000 formed in “layers” in which an initial layer is formed by nodes 1002 and a final layer is formed by nodes 1006. All or a portion of features of NN 1000 may be implemented in aspects of systems 100, 300, 400, 600 or 700 such as encoders 110, 116, 410, 416, 610, 710, 716 and 734, decoders 415, 416, 614 and/or 714, projectors 114 , 115, 715 and/or 738, extractor 604, feature pyramid network 628 and/or cascade mask R-CNN) 630, for example. Neural network (NN) 1000 may include an intermediate layer formed by nodes 1004. Edges shown between nodes 1002 and 1004 illustrate signal flow from an initial layer to an intermediate layer. Likewise, edges shown between nodes 1004 and 1006 illustrate signal flow from an intermediate layer to a final layer. While neural network 1000 shows a single intermediate layer formed by nodes 1004, it should be understood that other implementations of a neural network may include multiple intermediate layers formed between an initial layer and a final layer.

According to an embodiment, a node 1002, 1004 and/or 1006 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect. Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” or “input tensor” as referred to herein means an expression of one or more activation input values according to a particular structure, dimension and/or format. Likewise in this context, an “activation output tensor” or “output tensor” as referred to herein means an expression of one or more activation output values according to a particular structure, dimension and/or format.

According to an embodiment, neural network 1000 may be characterized as having a particular structure or topology based on, for example. a number of layers, number of nodes in each layers, activation functions implemented at each node, quantization of weights and quantization of input/output activations. Neural network 1000 may be further characterized by weights to be assigned to nodes to affect activation functions at respective nodes. During execution, neural network 1000 may be characterized as having a particular state or “intermediate state” determined based on values/signals computed by nodes (e.g., as activation values to be provided to nodes in a subsequent layer of nodes and/or an output tensor).

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing (e.g., medical records processing), brain-computer interfaces, financial time series, just to provide a few examples.

Another class of layered neural network may comprise a recursive neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

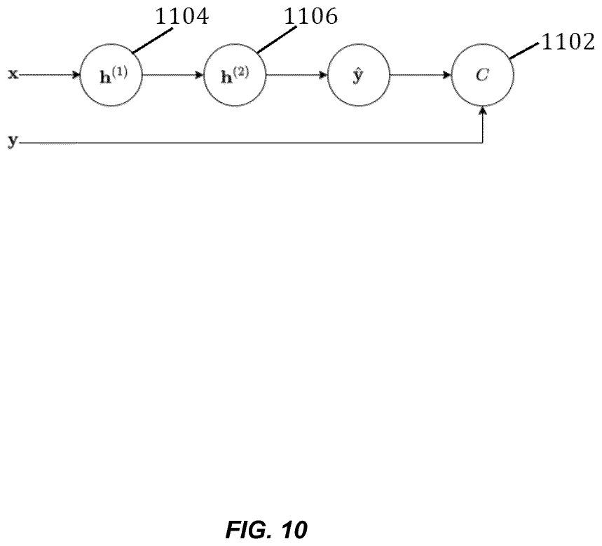

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ backpropagation techniques. “Backpropagation,” as referred to herein, is to mean a process of fitting parameters of a trained inference model such a model comprising one or more neural networks. In fitting parameters of a neural network, for example, backpropagation is to compute a gradient of a loss function with respect to the weights of the neural network. Based on such a computed gradient of a loss function, weights may be updated so as to minimize and/or reduce such a loss function. In one particular implementation, a gradient descent of a loss function, or variants such as stochastic gradient descent of a loss function, may be used. In training parameters of a neural network, backpropagation may comprise computing a gradient of a loss function with respect to individual weights by the chain rule, computing a gradient one layer at a time, iterating backward from the last layer to avoid redundant calculations of intermediate terms in the chain rule, for example. It should be understood, however, that this is merely an example of how a process of backpropagation may be applied, and claimed subject matter is not limited in this respect. In particular implementations, backpropagation may be used to iteratively update neural network weights to be associated with nodes and/or edges of a neural network based, at least in part on “training sets.” Such training sets may include training measurements and/or observations to be supplied as input values that are paired with “ground truth” observations. Based on a comparison of such ground truth observations and associated prediction values generated based on such input values in a training process, weights may be updated according to a loss function using backpropagation. FIGS. 10 is a flow diagram of an aspect of a training operation employing backpropagation to train parameters for a feedforward neural network, according to an embodiment. It should be understood, however, that this is merely an example of a type of neural network that may be trained using backpropagation, and that similar backpropagation techniques may be applied to train parameters of other types of neural networks without deviating from claimed subject matter. Training sets may be provided to such a training operation as pairs of vectors (x,y) where x is an input vector and y is a corresponding ground truth label. Input vector x may be provided as an input tensor to a first hidden layer 1104 to produce an output vector h⁽¹⁾, which is provided as an input to a second hidden layer 1106 to provide an output vector h⁽²⁾. An inference and/or prediction ŷ may be computed based, at least in part, on the output vector h⁽²⁾. A loss function C may be computed at 1102 based, at least in part, on inference and/or prediction ŷ and ground truth label y.

In the particular embodiment of FIG. 10, inference and/or prediction ŷ, and output vectors h⁽¹⁾ and h⁽²⁾ may be modelled as follows:

h⁽¹⁾=g⁽¹⁾(W^{(1)T}X+b⁽¹⁾)

h⁽²⁾=g⁽²⁾(W^{(2)T}h⁽¹⁾+b⁽²⁾)

ŷ(x)=W^{(3)T}h⁽²⁾+b⁽³⁾,

where:
g⁽ⁱ⁾ is an activation function applied at nodes in hidden layer i;
W⁽ⁱ⁾ is a matrix of weights such that weight Wⱼₖ⁽ⁱ⁾ is to be applied at an edge going from node j in layer i−1 to node k in hidden layer i; and
b⁽ⁱ⁾ is a bias matrix applied at hidden layer i.

In a particular implementation in which a feedforward neural network includes three or more hidden layers, computation of ŷ(x) may be generalized as follows:

ŷ(x)=W^{(N)T}h^{(N-1)}+b^{(N)}.

Loss function C(y,ŷ) may be computed according to any one of several formulations of a loss function as described above. In a particular implementation, C(y,ŷ) may be differentiable such that

$$\frac{\partial C}{\partial {W}_{jk}^{( i )}}$$

may be determined using the chain rule and may be computed for any weight Wⱼₖ⁽ⁱ⁾. According to an embodiment, values for W⁽ⁱ⁾ may be determined iteratively for training sets (x,y) using a gradient descent technique.

In this context, a “supervised operation” as referred to herein is to mean a machine-learning operation in which training sets provided as inputs for training iterations are paired with “ground truth” labels. In a training iteration/epoch of such a supervised operation, for example, a loss function may be computed based, at least in part, on an inference computed by a trainable model based on a training set and a ground truth label paired with the training set. For example, a supervised operation may compute a loss function based, at least in part, on a comparison of a computed inference and ground truth observations/values paired with the computed inference.

In this context, a “self-supervised operation” as referred to herein is to mean a machine-learning operation in which input training sets are provided without “ground truth” labels. In a training iteration/epoch of such a self-supervised operation, for example, a loss function may be computed based, at least in part, on an inference computed based on a training set and in the absence of any ground truth label paired with the training set.

Another embodiment disclosed herein is directed to a method of training a system for detection of objects in a content signal, the method comprising: applying a self-supervised operation to train parameters of an encoder and a decoder based, at least in part, on a first loss function based, at least in part, on a computed loss associated with reconstruction of a view of the content signal; and applying a supervised operation to further train parameters of the encoder and the decoder trained in the self-supervised operation based, at least in, in part, on a second loss function based, at least in part, on a computed loss associated with detection of objects. In one particular implementation, applying the self-supervised operation to train the parameters of the encoder and the decoder further comprises: computing a first term of the first loss function based, at least in part, on a reconstruction loss; computing a second term of the first loss function based, at least in part, on a contrastive loss; and updating of parameters of the decoder and decoder based, at least in part, on a gradient of the computed first and second terms of the first loss function. For example, computing the second term of the first loss function may comprise: applying of an instance of the decoder to multiple distinct views of a training set content signal to provide multiple encoded views; and computing a cross-correlation of projections of at least two of the encoded views. Also, applying the supervised operation may further comprise: computing the second loss function based, at least in part, on labeled data sets; and updating the parameters of the encoder and the decoder further based, at least in part, on a gradient of the second loss function. The supervised operation may further comprise: populating an input tensor to one or more neural networks with values based, at least in part, on intermediate states of the decoder; executing the one or more neural networks to compute an inference; and computing the second loss function further based, at least in part, on the computed inference. The second loss function may comprise at least a localization loss term and a classification loss term. The localization loss term is based, at least in part, on an inferred localization of detected objects within one or more bounding boxes defined in an image. The classification loss term may be based, at least in part, on an inferred classification of the detected objects. Also, applying the supervised operation may further comprise: updating parameters of an extractor to map the content signal to image patches. The extractor may comprise one or more neural networks.

Another embodiment disclosed herein is directed to a method comprising: extracting samples of a content signal; applying the extracted samples as an input to an encoder to provide an encoding of the extracted samples; applying the encoding of the extracted samples as an input to a decoder trained to provide a reconstruction of the content signal; populating an input tensor with values based, at least in part, on intermediate states of the decoder; executing the one or more neural networks to obtain an output tensor; and detecting one or more features in the content signal based, at least in part, on the output tensor. In one particular implementation, extracting samples from the content signal further comprises applying the content signal as an input to one or more layers of a neural network, the neural network to provide one or more samples of the content signal to a feature extractor to extract features. In another particular implementation, the one or more neural networks comprise a cascade mask region-based convolutional neural network. For example, the one or more neural networks comprise a feature pyramid network. In another particular implementation, parameters of the encoder and decoder are determined in executions of a self-supervised pretraining operation applied to a plurality of training sets of the content signal. For example, the self-supervised pretraining operation may comprise: computation of a first term of a loss function based, at least in part, on a reconstruction loss; computation of a second term of the loss function based, at least in part, on a contrastive loss; and update of parameters of the decoder and decoder based, at least in part, on a gradient of the loss function. Computation of the second term of the loss function may comprise: application of an instance of the decoder to multiple distinct views of a training set content signal to provide multiple encoded views; and computation of a cross-correlation of projections of at least two of the encoded views. The parameters of the encoder and decoder may be further determined in executions of a supervised training operation by applying labeled data sets.

Another embodiment disclosed herein is directed to a method of training a system for detection of objects, the method comprising: executing a first training operation to determine parameters of an encoder to transform samples of a content signal obtained from an electronic document to an embedded state, the embedded state comprising encoded samples of the content signal and tokens associating the encoded samples with positional references in the content signal, and to determine parameters of a decoder to transform the embedded state to a reconstruction of at least a portion of the content signal; and following the first training operation, executing a second training operation to determine parameters of one or more first neural networks to detect features in the content signal based, at least in part, on an input tensor populated with intermediate states of the decoder. In one particular implementation, the first training operation may comprise: computing a first term of a first loss function based, at least in part, on a reconstruction loss; computing a second term of the first loss function based, at least in part, on a contrastive loss; and updating of parameters of the encoder and decoder based, at least in part, on a gradient of the first loss function. For example, computing the second term of the first loss function may comprise: applying of an instance of the decoder to multiple distinct views of a training set content signal to provide multiple encoded views; and computing a cross-correlation of projections of at least two of the encoded views. In another particular implementation, the second training operation may further comprise: executing the one or more first neural networks to compute an inference; and computing a loss function based, at least in part, on the computed inference. For example, the loss function may comprise at least a localization loss term and a classification loss term. Also, the content signal may comprise screen images and/or screenshots of electronic health records; and the localization loss term and classification loss term may be computed based, at least in part, on locations and classifications of tables, table columns or graphical user interface (GUI) elements, or a combination thereof, in the screen images and/or screenshots. Additionally, the localization loss term may be based, at least in part, on an inferred localization of detected objects within one or more bounding boxes defined in an image. Furthermore, the classification loss term may be based, at least in part, on an inferred classification of the detected objects. In another particular implementation, the second training operation may further comprise: determining parameters of an extractor to map the content signal to the samples of the content signal. For example, the parameters of the extractor may comprise parameters of one or more second neural networks; and the input tensor may be further populated with intermediate states of the one or more second neural networks.

Another embodiment disclosed herein is directed to an apparatus comprising: an encoder to transform samples of a content signal obtained from an electronic document to an embedded state, the embedded state comprising encoded samples and tokens associating the encoded samples with positional references in the content signal; a decoder to transform the embedded state to a reconstruction of at least a portion of the content signal; one or more first neural networks to detect features in the content signal based, at least in part, on an input tensor populated with intermediate states of the decoder; and one or more processors to: execute a first training operation to determine parameters of the encoder and the decoder based, at least in part, on a gradient of a loss associated with the reconstruction of the at least a portion of the content signal; and following execution of the first training operation, execute a second training operation to determine parameters of one or more first neural networks based, at least in part, on a gradient of a loss associated with detection of features in the content signal. In one particular implementation, detection of features in the content signal may comprise an inference classification and localization of objects in the content signal. In another particular implementation, the first training operation may comprise: computation of a first term of a first loss function based, at least in part, on a reconstruction loss; and computation of a second term of the first loss function based, at least in part, on a contrastive loss, wherein parameters of the encoder and decoder to be updated based, at least in part, on a gradient of the first loss function. For example, computation of the second term of the first loss function may be based, at least in part, on: application of an instance of the decoder to multiple distinct views of a training set content signal to provide multiple encoded views; and computation of a cross-correlation of projections of at least two of the encoded views. In another particular implementation, the second training operation may further comprise: execution of the one or more first neural networks to compute an inference; and computation of a loss function based, at least in part, on the computed inference. For example, the loss function may comprise at least a localization loss term and a classification loss term. Also, the localization loss term may be based, at least in part, on an inferred localization of detected objects within one or more bounding boxes defined in an image. Additionally, the classification loss term may be based, at least in part, on an inferred classification of the detected objects. In another particular implementation, the second training operation may further comprise: determination of parameters of an extractor to map the content signal to the samples of the content signal. For example, the parameters of the extractor may comprise parameters of one or more second neural networks; and the input tensor may be further populated with intermediate states of the one or more second neural networks.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. An apparatus:
an encoder configured to transform samples of a content signal obtained from an electronic document retrieved from a memory to provide an embedded state, the embedded state comprising encoded samples and tokens associating the encoded samples with positional references in the content signal;
a decoder configured to transform the embedded state to provide a reconstruction of at least a portion of the content signal; and
one or more first neural networks to receive an input tensor populated with an intermediate state of the decoder, the one or more first neural networks to be configured to provide an output tensor comprising indications of detections of one or more features in the content signal based, at least in part, on the input tensor.

2. The apparatus of claim 1, wherein the decoder comprises one or more second neural networks, and wherein the input tensor is populated with one or more intermediate states of the one or more second neural networks.

3. The apparatus of claim 1, wherein the encoder comprises one or more third neural networks to extract the samples of the content signal, wherein the input tensor is further populated with an intermediate state of the one or more third neural networks.

4. The apparatus of claim 1, wherein:
the decoder comprises one or more second neural networks, and the input tensor is populated with one or more intermediate states of the one or more second neural networks;
the encoder comprises one or more third neural networks to extract the samples of the content signal, the input tensor is further populated with an intermediate state of the one or more third neural networks; and
the one or more second neural networks and the one or more third neural networks comprise weights to be applied at activation functions of the one or more second neural networks and the one or more third neural networks that are trained to reconstruct the content signal at an output of the decoder.

5. The apparatus of claim 4, wherein:
the content signal comprises one or more images; and
the one or more first neural networks comprise weights to be applied at activation functions of the one or more first neural networks to provide inferences of classifications and locations of objects in the one or more images.

6. The apparatus of claim 1, wherein:
the content signal comprises one or more images; and
the output tensor comprises indications of classifications and locations of objects in at least one of the one or more images.

7. The apparatus of claim 1, wherein the one or more first neural networks comprise a cascade mask region-based convolutional neural network.

8. The apparatus of claim 7, wherein the one or more first neural networks comprise a feature pyramid network.

9. A method comprising:
executing an encoder to transform samples of a content signal obtained from an electronic document to provide an embedded state, the embedded state comprising encoded samples and tokens associating the encoded samples with positional references in the content signal;
executing a decoder to process the embedded state, wherein parameters of the encoder and the decoder having been trained based, at least in part, on a reconstruction of one or more training sets of the content signal in an output state of the decoder; and
executing one or more first neural networks to provide an output tensor indicating detections of features in the content signal based, at least in part on an input tensor, the input tensor having been populated with one or more intermediate states of the decoder.

10. The method of claim 9, wherein:
the parameters of the encoder and the decoder having been trained based, at least in part, on a gradient of a loss function comprising a reconstruction loss component; and
the reconstruction loss component is based, at least in part, on a comparison of content signals in the one or more training sets and the reconstruction of content signals in the output state of the decoder.

11. The method of claim 10, wherein:
loss function further comprises a contrastive loss component; and
the contrastive loss component is determined based, at least in part, on:
application of an instance of the decoder to multiple distinct views of a training set content signal to provide multiple encoded views; and
computation of a cross-correlation of projections of at least two of the encoded views.

12. The method of claim 9, and further comprising executing an extractor to provide the samples of the content signal based, at least in part, on the electronic document, and wherein the input tensor having been further populated with one or more intermediate states of the extractor.

13. The method of claim 9, wherein the output tensor comprises classifications and locations of objects detected in the content signal.

14. The method of claim 13, wherein parameters of the encoder and decoder are further trained based, at least in part, on a gradient of at least a localization loss term and a classification loss term, the localization loss term and the classification loss term have been computed based on the output tensor and labeled data sets.

15. The method of claim 9, wherein the one or more first neural networks comprise a cascade mask region-based convolutional neural network.

16. The method of claim 15, wherein the one or more first neural networks comprise a feature pyramid network.

17. The method of claim 9, wherein:
the decoder comprises one or more second neural networks, and the input tensor is populated with one or more intermediate states of the one or more second neural networks;
the encoder comprises one or more third neural networks to extract the samples of the content signal, the input tensor is further populated with an intermediate state of the one or more third neural networks; and
the one or more second neural networks and the one or more third neural networks comprise weights to be applied at activation functions of the one or more second neural networks and the one or more third neural networks that are trained to reconstruct the content signal at an output of the decoder.

18. The method of claim 17, wherein:
the content signal comprises one or more images; and
the one or more first neural networks comprise weights to be applied at activation functions of the one or more first neural networks to provide inferences of classifications and locations of objects in the one or more images.

19. An article comprising:
a non-transitory storage medium comprising computer-readable instructions stored thereon that are executable by one or more processors of a computing device to:
execute an encoder to transform samples of a content signal obtained from an electronic document to provide an embedded state, the embedded state comprising encoded samples and tokens associating the encoded samples with positional references in the content signal;
execute a decoder to process the embedded state, wherein parameters of the encoder and the decoder having been trained based, at least in part, on a reconstruction of one or more training sets of the content signal in an output state of the decoder; and
execute one or more first neural networks to provide an output tensor indicating detections of features in the content signal based, at least in part on an input tensor, the input tensor having been populated with one or more intermediate states of the decoder.

20. The article of claim 19, wherein:
the decoder comprises one or more second neural networks, and the input tensor is populated with one or more intermediate states of the one or more second neural networks;
the encoder comprises one or more third neural networks to extract the samples of the content signal, the input tensor is further populated with an intermediate state of the one or more third neural networks; and
the one or more second neural networks and the one or more third neural networks comprise weights to be applied at activation functions of the one or more second neural networks and the one or more third neural networks that are trained to reconstruct the content signal at an output of the decoder.
